(19) United States
(12) Patent Application Publication
(10) Pub. No.: US 2026/0238244 A1
(43) Pub. Date: Aug. 13, 2026

(54) COMMUNICATION CONTROL DEVICE, WIRELESS ACCESS SYSTEM, COMMUNICATION CONTROL METHOD, AND PROGRAM

(71) Applicant: NTT, Inc., Tokyo (JP)

(72) Inventors: Ikuo OTANI, Tokyo (JP); Kei FUJIMOTO, Tokyo (JP); Katsumi FUJITA, Tokyo (JP)

(73) Assignee: NTT, Inc., Tokyo (JP)

(21) Appl. No.: 19/151,634

(22) PCT Filed: Jan. 31, 2023
(86) PCT No.: PCT/JP2023/003044

§ 371 Date: Jul. 29, 2025

(51) Int. Cl. H04B 1/38

(52) U.S. Cl. CPC H04B 1/38

(57) ABSTRACT

A communication control device that processes a radio access signal includes a communication quality information acquisition unit that acquires communication quality information, a processing time estimation unit that calculates an estimated processing time for each CPU frequency from the acquired communication quality information, and a frequency control unit that lowers the CPU frequency than a currently set CPU frequency, within a range where the estimated processing time is equal to or less than a processing time of a timeslot. The communication quality information acquisition unit works as an MCS acquisition unit, a radio wave condition acquisition unit, an MAC schedule analysis unit, and a delay time acquisition unit.

### TECHNICAL FIELD

The present invention relates to a communication control device, a wireless access system, a communication control method, and a program.

### BACKGROUND ART

In a radio access network (RAN), data transfer is sequentially executed for each specific time segment (timeslot) to implement low-delay communication. In the RAN, communication from a user terminal (UE) to a core network has been mostly implemented using a dedicated device.

In a virtual radio access network (vRAN) in which a base station of the RAN is implemented with software and a general-purpose server, an accelerator is used or tuning such as maximizing the frequency of a CPU is performed to clear a strict time constraint on the order of microseconds, in order to execute heavy processing.

### <VRAN>

The vRAN will be described.

A wireless access system for mobile communication is required to have high latency requirements and high throughput, and thus, a base station (BBU) to process radio signals has generally been supported by dedicated hardware (dedicated device).

With widespread use of a general-purpose server (Intel (registered trademark) architecture (IA) server) in recent years, the general-purpose server has been dramatically improved in performance, and can be obtained at low cost through mass production. As a result, the vRAN using a general-purpose server has been considered for processing radio signals at a BBU in a long term evolution (LTE) and/or a 5G wireless access system.

In the vRAN, a general-purpose server that is inexpensive and available in large quantities can be used as hardware of the BBU, so that a server rack with a plurality of general-purpose servers may be set up in advance in a regional data center (DC) or a telecommunications building within several 10 km from an antenna, as an aggregation base, to construct a BBU pool (this concept may be referred to as centralized-RAN (C-RAN)).

The BBU pool allows a plurality of base station hardware units (general-purpose servers) to be prepared in advance, and thus has a potential advantage of enabling flexible operation such as quick hardware replacement (switching) at the time of hardware failure and dynamic scale-out/in (hereinbelow, “/” denotes “or”) according to an increase or decrease in traffic.

In the wireless access system, base station functions may be separated into a radio unit (RU)/a distributed unit (DU)/a centralized unit (CU).

Functions of the RU/DU/CU will be described.

The functions of the RU include PHY-low, AD/DA conversion, iFFT, analog beamforming, and digital beamforming. The functions of the DU include PHY-high, modulation and demodulation, encoding/decoding, scrambling, and MAC, and these are processed by a DU server. The functions of the CU include execution of packet data convergence protocol, radio resource control, and service data adaptation protocol.

In EPC/5GC mobile communication, functions of a BBU are provided in the DU and the CU, and a function of a remote radio head (RRH) to process a radio frequency (RF) is provided in the RU. Most of general base stations are installed as slave stations having only the RU as a facility, and a base station including the DU and the CU is referred to as a master station and is connected to the slave station through a network referred to as a fronthaul.

In addition, the BBU pool can be pooled by CPU core, accelerator, or network interface card (NIC) in a server, which is a unit smaller than the separative units of the RU, the DU, or the CU.

An overview of a vRAN system will be described.

FIG. 46 illustrates an overview of a vRAN system.

As illustrated in FIG. 46, a vRAN system (wireless access system) 1 includes a terminal (user equipment (UE)) 10, an RU 20 having an antenna (base station antenna), a DU server 30, a CU server 40, and a core network 50.

In a wireless access system, transmission timings of radio signals between a terminal and a base station are managed, as resources multiplexed in a time domain and a frequency domain, by a medium access control (MAC) Scheduler in the base station. The DU server 30 allocates and manages a resource element (RE) to each UE 10.

The UE 10 is a wireless device such as a mobile phone terminal, and is connected to the RU 20 via a wireless section.

The UE 10 converts data to be transmitted into a radio signal and transmits the radio signal to the RU 20. The UE 10 performs signal processing on the radio signal received from the RU 20 to decode it to the data intended by the transmission source.

There are two types of communication between the UE 10 and the RU 20: uplink (UE 10 to RU 20 to DU server 30) (hereinafter, appropriately referred to as UL) and downlink (DU server 30 to RU 20 to UE 10) (hereinafter, appropriately referred to as DL).

The RU 20 comprises an antenna and a transceiver unit that wirelessly communicates with the UE 10 (hereinafter, “antenna” collectively refers to the antenna, the transceiver unit, and its power supply unit). The transceiver unit is connected to the DU server 30 via a dedicated cable, for example.

The RU 20 is a base station for the UE 10, and transmits and receives a radio signal to and from the UE 10.

The RU 20 performs computing of a part of the radio signal received from the UE 10 and then transmits the radio signal to the DU server 30.

The RU 20 performs transmission and reception described below to/from the UE 10.

Downlink: Transmitting a radio signal to the UE 10.

Downlink: Receiving signal data from the DU server 30 via a fronthaul interface unit (not shown).

Uplink: Receiving a radio signal from the UE 10.

Uplink: Transmitting signal data to the DU server 30 via a fronthaul interface unit (not shown).

The DU server 30 performs radio signal processing in an LTE or fifth generation (5G) wireless access system using a general-purpose server. In the vRAN, a general-purpose server that is inexpensive and available in massive quantities can be used as the DU server 30.

The DU server 30 includes hardware (HW) 31, an OS 32, and a virtualized distributed unit (vDU) 33 that executes a base station processing application (APL).

The hardware (HW) 31 includes a central processing unit (CPU) 31a, an accelerator 31b including a field-programmable gate array (FPGA)/an application specific integrated circuit (ASIC)/a graphics processing unit (GPU), and a network interface card (NIC) 31c.

The accelerator 31b is accelerator hardware specialized for a specific operation and mounted on the DU server 30, and performs operation on the basis of an instruction from an accelerator offload unit (not shown). The CPU 31a offloads, for example, forward error correction (FEC) processing to the accelerator 31b via the accelerator offload unit.

The NIC 31c is an input/output mechanism that performs data input/output to/from the accelerator 31b and an external device (RU 20).

The CU server 40 includes a general-purpose server 41 and a virtualized centralized unit (vCU) 42.

The core network 50 is an evolved packet core (EPC)/5G core network (5GC), or the like.

FIG. 47 illustrates correspondence between communication layers of the UE 10 and the RAN (RU 20, vDU 33, and vCU 42) in the vRAN system (radio access system) 1 in FIG. 46.

A physical layer (PHY) of the UE 10 is connected to a communication layer of PHY-low of the RU 20.

Media access control (MAC) of the UE 10 is connected to a communication layer of MAC of the vDU 33 as the DU server 30, and radio link control (RLC) of the UE 10 is connected to a communication layer of RLC of the vDU 33 as the DU server 30. Note that the vDU 33 as the DU server 30 executes PHY-high processing.

Packet data convergence protocol (PDCP) of the UE 10 is connected to a communication layer of PDCP of the vCU 42, and service data adaptation protocol (SDAP) of the UE 10 is connected to a communication layer of SDAP of the vCU 42.

PHY processing is described in Non-Patent Literature 1.

FIG. 48 illustrates processing for each timeslot of downlink data processing (DL) of transmitting data from the vDU 33, as the DU server 30, to the UE 10 via the RU 20 and uplink data processing (UL) of transmitting data from the UE 10 to the vDU 33, as the DU server 30, via the RU 20.

In the RAN, data transfer is sequentially executed for each specific time segment (timeslot) to implement low-delay communication. The PHY-high processing of the vDU 33 as the DU server 30 must be processed within a timeslot of several hundred us (see arrow a in FIG. 48).

In the case of time division multiplexing (TDD), UL and DL are scheduled in the wireless section so as to avoid temporal overlap (see reference sign b in FIG. 48).

FIG. 49 illustrates a breakdown of the PHY-high processing in the timeslot for UL of the vDU 33, as the DU server 30, in FIG. 48.

The timeslot illustrated in FIG. 49 is in several hundred us, for example, and the PHY-high processing (UL) occupies a large proportion thereof. The PHY-high processing (UL) includes processing of demapping 51, demodulation 52, decoding (FEC decoding) 53, and cyclic redundancy check (CRC) check.

Since the decoding (FEC decoding) processing included in the PHY-high processing (UL) includes parallel processing that the CPU 31a is not good at, it is offloaded to the accelerator 31b, but it still takes several hundred us, to become a bottleneck in achieving the processing within the timeslot.

FIG. 50 illustrates an image of offloading (Look-Aside type) of the PHY-high processing (UL) in FIG. 49.

The accelerator 31b illustrated in FIG. 50 is an operation unit mounted on the DU server 30 and specialized for specific processing. The accelerator 31b is connected with the CPU 31a via a bus in such a form of an ASIC accelerator, an FPGA accelerator, and a GPU.

An arrow (arrow c in FIG. 50) starting from the CPU 31a to the accelerator 31b and returning from the accelerator 31b to the CPU 31a in FIG. 50 is a signal path in the case of the Look-Aside type of ACC offloading. In the Look-Aside type, data to be processed by the accelerator 31b is input from the CPU 31a. Note that, although not illustrated, there is also an In-Line type in which data is directly input from an input/output unit such as the NIC 31c to the accelerator 31b. In the case of the In-Line type of ACC offloading, a bidirectional signal line connecting the NIC 31c with the accelerator 31b is provided.

### PRIOR ART LITERATURES

### Non-Patent Literatures

Non-Patent Literature 1: “SPECIFICATION OF PHYSICAL LAYER in 5G NR”, NTT DOCOMO, DOCOMO Technical Journal, Vol. 26 No. 3 (November 2018), [online], [retrieved on Jan. 16, 2023], the Internet <URL: https://www.docomo.ne.jp/binary/pdf/corporate/technology/rd/technical_journal/bn/vol26_3/vol26_3_008jp.pdf>
Non-Patent Literature 2: “MCS”, [online], [retrieved on Jan. 16, 2023], the Internet <URL: https://www.techplayon.com/5g-nr-modulation-and-coding-scheme-modulation-and-code-rate/>

### SUMMARY OF THE INVENTION

### Problems to be Solved

With the conventional technique, in order to complete all processing within a timeslot even under various conditions in uplink PHY-high processing (UL), it is necessary to continuously set the CPU core and the accelerator to the highest performance setting. Hereinafter, problems are described in controlling a CPU core frequency (when the CPU core is not focused, it is simply referred to as a CPU frequency) and processing the PHY-high.

FIG. 51 illustrates control of the CPU core frequency.

The DU server 30 illustrated in FIG. 46 includes hardware 60, a driver 70, and a governor 80. The hardware 60 illustrated in FIG. 51 corresponds to the HW 31 in FIG. 46. In addition, the driver 70 and the governor 80 illustrated in FIG. 51 are included in the OS 32 in FIG. 46.

The hardware 60 includes a CPU Core 61. The driver 70 includes an intel P-state 71 (“intel” is a registered trademark) and an ACPI cpufreq 72. The governor 80 includes an intel P-state cpufreq 81 (“intel” is a registered trademark) and a core cpufreq 82.

There are two methods for controlling the CPU core frequency (CPU frequency) as described below. The governor 80 determines a CPU core frequency variation range and a variation policy using the intel P-state cpufreq 81 and gives an instruction to the intel P-state 71 of the driver 70. The intel P-state 71 controls the frequency of the CPU Core 61. Similarly, the governor 80 determines a CPU core frequency variation range and a variation policy using the core cpufreq 82 and gives an instruction to the ACPI cpufreq 72 of the driver 70. The ACPI cpufreq 72 controls the frequency of the CPU Core 61.

For example, the governor 80 sets cpufreq_performance to continuously operate the CPU Core 61 at the maximum frequency. In addition, the governor 80 can dynamically vary the frequency of the CPU Core 61 by setting cpufreq_ondemand. The governor 80 can continuously operate the CPU Core 61 at the minimum frequency by setting cpufreq_powersave.

FIG. 52 illustrates patterns of a PHY-high processing (UL). An upper chart in FIG. 52 illustrates a timeslot that takes time in decoding, a middle chart in FIG. 52 illustrates a timeslot that does not take time in decoding, and a lower chart in FIG. 52 illustrates a timeslot without PHY-high processing (UL).

As can be seen by comparing the timeslot in the upper chart in FIG. 52 with the timeslot in the middle chart in FIG. 52, it is necessary to continuously set the CPU Core 61 to the highest performance, in order to complete all of the PHY-high processing (UL) within the timeslot. To continuously set the CPU Core 61 to the highest performance, the governor 80 sets cpufreq_performance using the intel P-state cpufreq 81 or the core cpufreq 82.

As described above, in such a case where the vRAN system is configured, it is assumed that the operation frequency of the CPU is set to the maximum because high-speed processing is required. Since the CPU Core 61 operates at the maximum frequency, there is a problem that the power consumption increases regardless of the presence or absence of remaining buffer time (see the middle chart in FIG. 52) or the timeslot without the PHY-high processing (UL) (see the lower part of FIG. 52).

Especially in a case where the uplink PHY-high processing is executed by the CPU, it is necessary to continuously set the CPU core and the accelerator to the highest performance in order to complete all the processing within the timeslot even under various conditions. In this case, since the CPU core and the like operate at the maximum frequency, there remains a problem of increasing power consumption.

The present invention has been made in view of such a background, and an object of the present invention is to reduce power consumption of a CPU and an accelerator in such a case of configuring a vRAN system, while requirements of high-speed processing are satisfied.

### Solution to Problem

In order to solve the above-described problem, a communication control device that is arranged in a base station and processes a radio access signal includes: a communication quality information acquisition unit that acquires communication quality information; a processing time estimation unit that calculates an estimated processing time for each CPU frequency from the acquired communication quality information; and a frequency control unit that lowers the CPU frequency than a currently set CPU frequency, within a range where the estimated processing time is equal to or less than a processing time of a timeslot.

### Advantageous Effects of Invention

According to the present invention, power consumption of a CPU and an accelerator is reduced in such a case of configuring a vRAN system, while requirements of high-speed processing are satisfied.

### BRIEF DESCRIPTION OF DRAWINGS

FIG. 1 shows a schematic configuration of a wireless access system according to a first embodiment of the present invention;

FIG. 2 shows a chart indicating a UBLER of Uplink, having a CRC check resulted in error depending on a combination of an SNR and a current MCS Index, in the wireless access system according to the first embodiment of the present invention;

FIG. 3 shows a table of combinations for selecting an MCS Index based on an SNR and a UBLER, in the wireless access system according to the first embodiment of the present invention;

FIG. 4 shows a flowchart of an overview of learning processing time of a PHY-high based on an MCS Index, in the wireless access system according to the first embodiment of the present invention;

FIG. 5 shows a study results table of processing time of a PHY-high for each setting of a MCS, in the wireless access system according to the first embodiment of the present invention;

FIG. 6 shows a flowchart of a process of setting a CPU frequency, during operation of the wireless access system according to the first embodiment of the present invention, to estimate a PHY-high processing time based on an MCS Index and a SINR and lower a setting on performance of a CPU frequency;

FIG. 7 illustrates operation of a first essential point of the wireless access system according to the first embodiment of the present invention;

FIG. 8 illustrates deriving a settable CPU frequency based on estimation of a PHY-high processing time, in the wireless access system according to the first embodiment of the present invention;

FIG. 9 illustrates operation of the first essential point of the wireless access system according to the first embodiment of the present invention;

FIG. 10 illustrates deriving a settable CPU frequency based on estimation of a PHY-high processing time, in the wireless access system according to the first embodiment of the present invention;

FIG. 11 illustrates operation of a second essential point of the wireless access system according to the first embodiment of the present invention;

FIG. 12 illustrates processing for each timeslot of downlink data processing (DL) to transmit data from a vDU, as a DU server, to an RU and uplink data processing (UL) to transmit data from the RU to the vDU, as the DU server, in the wireless access system according to the first embodiment of the present invention;

FIG. 13 illustrates deriving a settable CPU frequency, based on estimation of a PHY-high processing time, in the wireless access system according to the first embodiment of the present invention;

FIG. 14 illustrates deriving a settable CPU frequency, based on estimation of a PHY-high processing time, in the radio access system according to the first embodiment of the present invention;

FIG. 15 illustrates operation of a third essential point of the wireless access system according to the first embodiment of the present invention;

FIG. 16 illustrates a timeslot of PHY-high processing (UL) for MCS: 3, in the wireless access system according to the first embodiment of the present invention;

FIG. 17 illustrates an example of rewriting a table value of the study results table, based on a PHY-high processing time, in the wireless access system according to the first embodiment of the present invention;

FIG. 18 shows an example of a table of a mixed DB used for processing time for communication in both directions, in the wireless access system according to the first embodiment of the present invention;

FIG. 19 shows an example of a table of a UL DB used for processing time for only UL, in the wireless access system according to the first embodiment of the present invention;

FIG. 20 shows an example of a table of a DL DB, in the wireless access system according to the first embodiment of the present invention;

FIG. 21 shows a CPU frequency setting history table in the wireless access system according to the first embodiment of the present invention;

FIG. 22 is a control target table in the wireless access system according to the first embodiment of the present invention;

FIG. 23 illustrates temporal handling of timeslots for downlink data processing (DL) to transmit data from the vDU, as the DU server, to the RU and uplink data processing (UL) to transmit data from the RU to the vDU, as the DU server, in the wireless access system according to the first embodiment of the present invention;

FIG. 24 is an example of an MAC-PHY conversion table in the wireless access system according to the first embodiment of the present invention;

FIG. 25 shows an example configuration of the DU server in a case where UL/DL tasks are loaded onto all over the controlled CPU cores, in the wireless access system according to the first embodiment of the present invention;

FIG. 26 shows an example configuration of the DU server in a case where the UL/DL tasks are respectively loaded onto different CPU cores, in the wireless access system according to the first embodiment of the present invention;

FIG. 27 illustrates a timeslot of PHY-high processing (DL) for MCS: 3, in the wireless access system according to the first embodiment of the present invention;

FIG. 28 illustrates an example of rewriting a table value of the study results table, based on a PHY-high processing time, in the wireless access system according to the first embodiment of the present invention;

FIG. 29 shows a flowchart of process of estimating processing time by a processing time estimation unit, in the wireless access system according to the first embodiment of the present invention;

FIG. 30 shows a subroutine of the process of estimating processing time in a case where UL/DL tasks are loaded onto all over the controlled CPU cores, in the wireless access system according to the first embodiment of the present invention;

FIG. 31 shows a subroutine of the process of estimating processing time in a case where UL/DL tasks are respectively loaded onto different CPU cores, in the wireless access system according to the first embodiment of the present invention;

FIG. 32 shows a subroutine of feedback process to be controlled by a delay time acquisition unit, in the wireless access system according to the first embodiment of the present invention;

FIG. 33 shows a subroutine of feedback process executed by the processing time estimation unit, in the wireless access system according to the first embodiment of the present invention;

FIG. 34 shows an image chart of a change being cascaded to values for other MCS Indexes and CPU frequencies in tables in the DL DB, in the wireless access system according to the first embodiment of the present invention;

FIG. 35 shows a flowchart of controlling the CPU frequency in cases where UL/DL tasks are loaded onto all over the controlled CPU cores, in the wireless access system according to the first embodiment of the present invention;

FIG. 36 shows a flowchart of controlling the CPU frequency in cases where UL/DL tasks are respectively loaded onto different CPU cores, in the wireless access system according to the first embodiment of the present invention;

FIG. 37 shows a schematic configuration of a wireless access system according to a second embodiment of the present invention;

FIG. 38 shows a flowchart of controlling accelerator frequency by a frequency control unit, in the wireless access system according to the second embodiment of the present invention;

FIG. 39 shows a schematic configuration of a wireless access system according to a third embodiment of the present invention;

FIG. 40 illustrates an uncore setting table read by a frequency control unit, in the wireless access system according to the third embodiment of the present invention;

FIG. 41 illustrates a configuration of a CPU socket including a CPU core and an uncore, in the wireless access system according to the third embodiment of the present invention;

FIG. 42 shows a chart indicating delay performance (us) for an uncore frequency, in the wireless access system according to the third embodiment of the present invention;

FIG. 43 is a flowchart of controlling uncore frequency in a case where UL/DL tasks are loaded onto all over the controlled CPU cores, in the wireless access system according to the third embodiment of the present invention;

FIG. 44 is a flowchart of controlling uncore frequency in a case where UL/DL tasks are respectively loaded onto different CPU cores, in the wireless access system according to the third embodiment of the present invention;

FIG. 45 is an example hardware configuration of a computer that implements functions of a communication control device of the wireless access system according to the embodiment of the present invention;

FIG. 46 illustrates an overview of a vRAN system;

FIG. 47 illustrates correspondence between communication layers of a UE and a RAN in the vRAN system in FIG. 46;

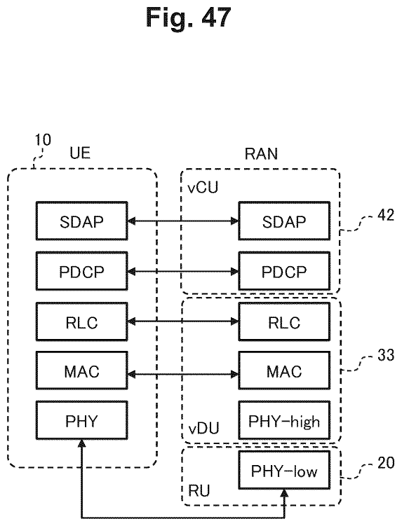

FIG. 48 illustrates processing for each timeslot of downlink data processing (DL) of transmitting data from a vDU, as a DU server, to a UE via an RU and uplink data processing (UL) of transmitting data from the UE to the vDU, as the DU server, via the RU;

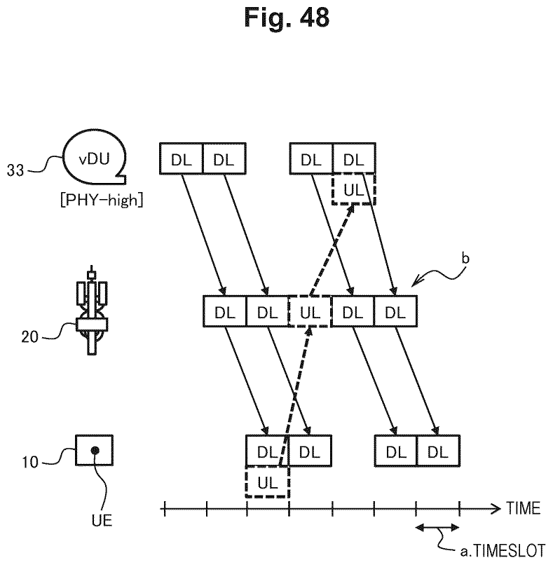

FIG. 49 illustrates a breakdown of PHY-high processing in a timeslot for UL of the vDU, as the DU server, in FIG. 48;

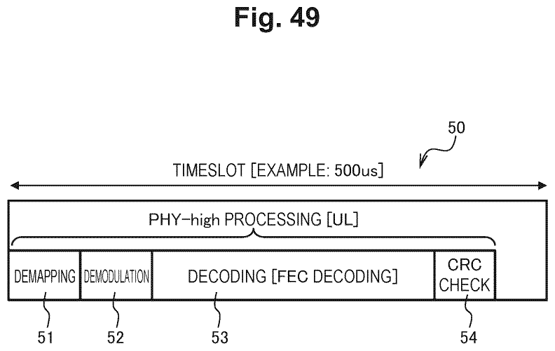

FIG. 50 illustrates an image of offloading (Look-Aside type) of the PHY-high processing (UL) in FIG. 49;

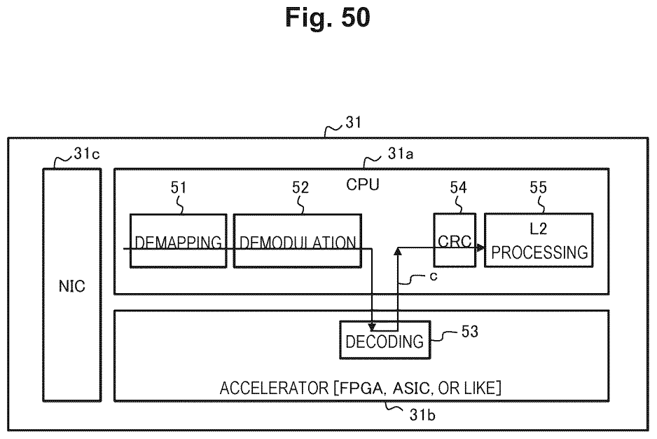

FIG. 51 illustrates control of a CPU core frequency; and

FIG. 52 illustrates patterns of a PHY-high processing (UL).

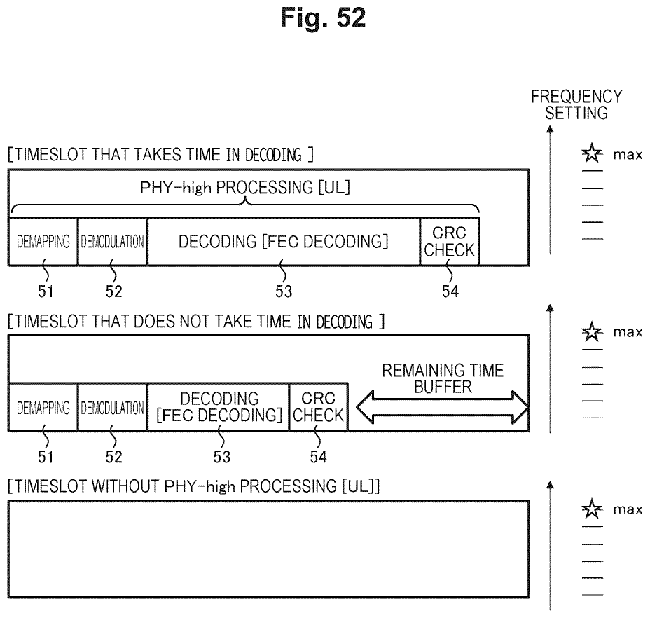

### DESCRIPTION OF EMBODIMENTS

### First Embodiment

### Overview

Hereinafter, a wireless access system and the like in an embodiment of the present invention (hereinafter, referred to as “the present embodiment”) will be described with reference to the drawings.

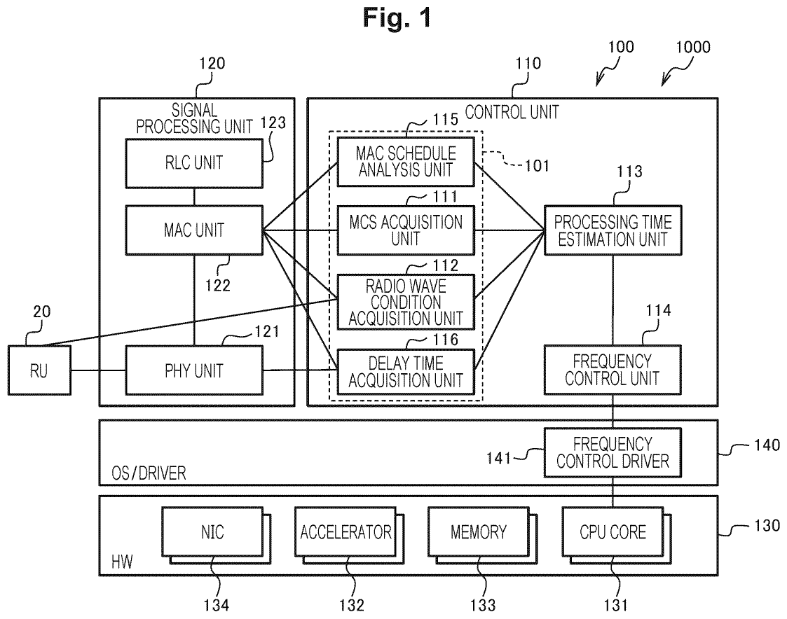

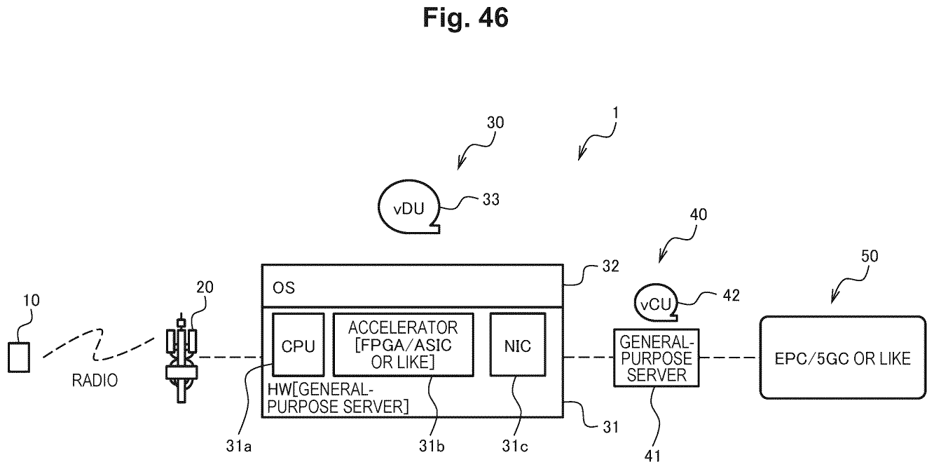

FIG. 1 shows a schematic configuration of a wireless access system according to a first embodiment of the present invention. The present embodiment is applicable to a wireless access system of EPC/5GC mobile communication. The same components as those in FIG. 46 are denoted by the same reference numerals.

The present embodiment is an example in which a communication control device that processes a wireless access signal is applied to a device arranged in a base station that processes a wireless access signal. Especially in a vRAN environment, when the present invention is applied, the communication quality information may be read as radio quality information.

As illustrated in FIG. 1, a wireless access system 1000 includes an RU 20 and a communication control device 100.

The communication control device 100 is a wireless access device mounted on the DU server 30 in FIG. 46.

The communication control device 100 includes a control unit 110, a signal processing unit 120, hardware (HW) 130, and an OS/driver 140.

### [Control Unit 110]

The control unit 110 includes a modulation and coding scheme (MCS) acquisition unit 111, a radio wave condition acquisition unit 112, a processing time estimation unit 113, a frequency control unit 114, a media access control (MAC) schedule analysis unit 115, and a delay time acquisition unit 116.

The MCS acquisition unit 111, the radio wave condition acquisition unit 112, the MAC schedule analysis unit 115, and the delay time acquisition unit 116 correspond to a communication quality information acquisition unit 101 that acquires the communication quality information.

### <MCS Acquisition Unit 111>

The MCS acquisition unit 111 acquires an MCS Index from a MAC unit 122 of the signal processing unit 120. Specifically, the MCS acquisition unit 111 acquires a UL or DL MCS index for a specific MAC timeslot from the MAC unit 122, and provides the MCS Index to the processing time estimation unit 113.

The MCS is indexed (referred to as MCS Index) using a spatial stream, a modulation scheme, and a coding rate as parameters (see Non-Patent Literature 2). The MCS Index is defined in 77 stages in IEEE802.11n.

### <Radio Wave Condition Acquisition Unit 112>

The radio wave condition acquisition unit 112 acquires radio wave quality information (such as SINR and RSRQ) for UL from the RU 20 and provides the radio wave quality information to the processing time estimation unit 113.

In addition, the radio wave condition acquisition unit 112 acquires DL radio wave quality information (such as SINR, RSRQ, and COI) from the MAC unit 122 and provides the radio wave quality information to the processing time estimation unit 113.

Note that the radio wave quality information measured by using a CSI reference signal is reported to the MAC unit 122 as a CSI report.

### <Basic Function of Processing Time Estimation Unit 113>

The processing time estimation unit 113 calculates an estimated processing time for each CPU frequency from the acquired communication quality information. Specifically, based on PHY schedule information, the processing time estimation unit 113 estimates the processing time of each of PHY timeslots for respective situations of both UL and DL directions, only UL, only DL, and none in any directions. As a result, accuracy improvement in both directions in consideration of DL processing and further power saving in the PHY timeslot that does not require handling are achieved.

The processing time estimation unit 113 corrects the estimation method on the basis of processing time of the PHY-high (or PHY-high processing time). In addition, the delay time acquisition unit 116 acquires the presence or absence of a retransmission request from the MAC unit 122 and provides the information to the processing time estimation unit 113. The accuracy of the CPU control can be improved through the feedback in consideration of the server operation status.

### <Estimating Processing Time of Specific PHY Timeslot by Processing Time Estimation Unit 113>

The processing time estimation unit 113 acquires MACPHY schedule conversion information. In addition, the processing time estimation unit 113 acquires the UL or DL radio wave quality information from the radio wave condition acquisition unit 112.

The processing time estimation unit 113 acquires a UL or DL MCS Index for a specific MAC timeslot from the MCS acquisition unit 111, and converts the UL or DL MCS Index into a UL or DL MCS Index for a PHY timeslot, based on the MACPHY schedule conversion information.

The processing time estimation unit 113 acquires PHY schedule information from the MAC schedule analysis unit 115. The processing time for each CPU frequency is estimated using specific logic, based on the UL or DL MCS Index for the PHY timeslot and the PHY schedule information.

The processing time estimation unit 113 may use the UL or DL radio wave quality information for estimation in a case where the MCS Index cannot be used or in order to improve accuracy. The processing time estimation unit 113 provides the frequency control unit 114 with the MCS Index of the PHY timeslot and the lowest frequency.

### <Feedback in Estimating Processing Time by Processing Time Estimation Unit 113 (Part 1)>

The processing time estimation unit 113 can also execute feedback processing in estimating the PHY-high processing time, on the basis of time stamp information acquired by PHY and the presence or absence of a retransmission request. Specifically, the processing time estimation unit 113 acquires each processing time of the UL PHY-high processing and the presence or absence of an UL retransmission request from the delay time acquisition unit 116. The processing time estimation unit 113 corrects the processing time estimation logic, on the basis of each processing time of the UL PHY-high processing. In order to improve the accuracy, information of the presence or absence of the UL retransmission request may be used for logic correction.

### <Feedback in Estimating Processing Time by Processing Time Estimation Unit 113 (Part 2)>

The processing time estimation unit 113 includes a study results table that associates the PHY-high processing time for each MCS Index or radio wave quality information with the CPU frequency, and the processing time estimation unit 113 refers to the study results table to determine the lowest frequency among the CPU frequencies in the study results table, within a range where an estimated processing time is equal to or less than the processing time of the timeslot.

### <Frequency Control Unit 114>

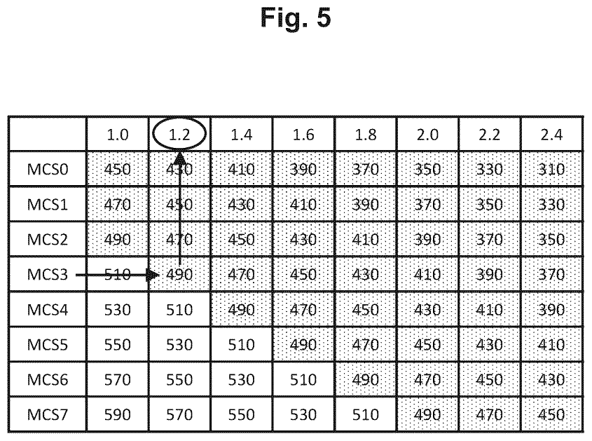

The frequency control unit 114 lowers the CPU frequency than the currently set CPU frequency, within a range where the estimated processing time is equal to or less than the processing time of the timeslot. Specifically, the frequency control unit 114 refers to the study results table (FIGS. 5, 6, 8, and the like) learned in advance, and lowers the CPU frequency to the CPU frequency retrieved from the PHY-high processing time indicated by the MCS Index, for example. At this time, the set CPU frequency is a CPU frequency (lowest frequency) at which the processing is expected to complete just barely within the timeslot. In addition, the frequency control unit 114 determines the CPU frequency in the PHY timeslot, based on the MCS Index and the frequency (for example, the lowest frequency) presented from the processing time estimation unit 113, in consideration of a safety factor. The frequency control unit 114 controls a frequency control driver 141, based on the determined CPU frequency, to change the CPU frequency.

### <MAC Schedule Analysis Unit 115>

The MAC schedule analysis unit 115 acquires radio resource arrangement information (MAC schedule information) from the MAC unit 122 of the signal processing unit 120 and converts the information into resource arrangement information (PHY schedule information) in PHY-high. The MAC schedule analysis unit 115 provides the PHY schedule information to the processing time estimation unit 113.

The MAC schedule analysis unit 115 creates a PHY-MAC conversion table, in consideration of the delay in PHY and the wireless section.

### <Delay Time Acquisition Unit 116>

The delay time acquisition unit 116 acquires an actual PHY-high processing time from a PHY unit 121 and provides the actual PHY-high processing time to the processing time estimation unit 113.

The delay time acquisition unit 116 acquires a time stamp at each point during the UL PHY-high processing from the PHY unit 121 of the signal processing unit 120. The delay time acquisition unit 116 calculates a delay time in each processing and provides the delay time to the processing time estimation unit 113. The delay time acquisition unit 116 acquires the presence or absence of an UL retransmission request from the MAC unit 122 of the signal processing unit 120 and provides the presence or absence to the processing time estimation unit 113.

### [Signal Processing Unit 120]

The signal processing unit 120 is the vDU 33 as the DU server 30 in FIG. 46.

The signal processing unit 120 includes the PHY unit 121, the MAC unit 122, and a radio link control (RLC) unit 123, and the respective units are implemented through a vDU, that is, software (APL).

The PHY unit 121 processes modulation, encoding, multiplexing of antenna and the like in Layer 1.

The MAC unit 122 performs radio resource allocation, data mapping, retransmission control, and the like in Layer 2.

The RLC unit 123 performs retransmission control, duplication detection, and order alignment in Layer 2.

### [HW 130]

The HW 130 includes a CPU core 131, an accelerator 132, a memory 133, and an NIC 134.

The CPU core 131 corresponds to the CPU 31a of the HW 31 in FIG. 46, the accelerator 132 corresponds to the accelerator 31b of the HW 31 in FIG. 46, and the NIC 134 corresponds to the NIC 31c of the HW 31 in FIG. 46.

### [OS/Driver 140]

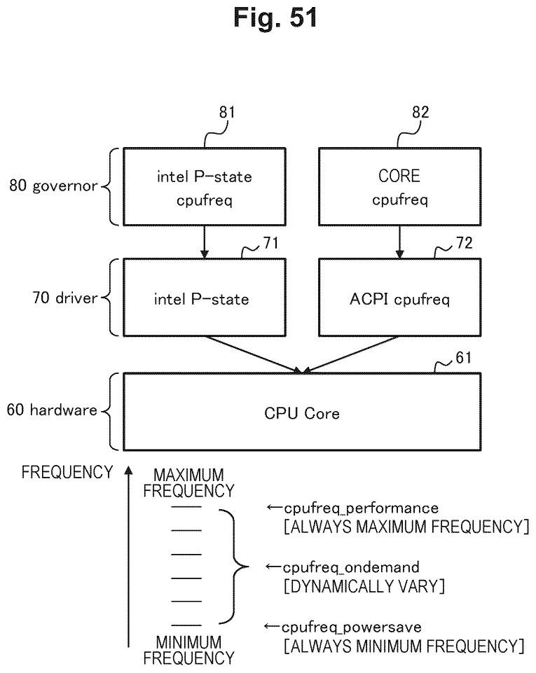

The OS/driver 140 corresponds to the OS 32 in FIG. 46, and further includes the frequency control driver 141. The frequency control driver 141 corresponds to the driver 70 in FIG. 51.

### [Relationship Between SNR by MCS, and BLER]

A relationship between the SNR (signal noise ratio) by the MCS, and the BLER (block error rate) is described.

In the present embodiment, the MCS acquisition unit 111 acquires the MCS Index from the MAC unit 122 of the signal processing unit 120, and provides the MCS Index to the processing time estimation unit 113. Alternatively, when the MCS Index cannot be used or in order to improve accuracy, the radio wave condition acquisition unit 112 acquires the UL radio wave quality information (SINR, RSRQ, or the like), as an alternative to the MCS Index, from the RU 20 and provides the information to the processing time estimation unit 113.

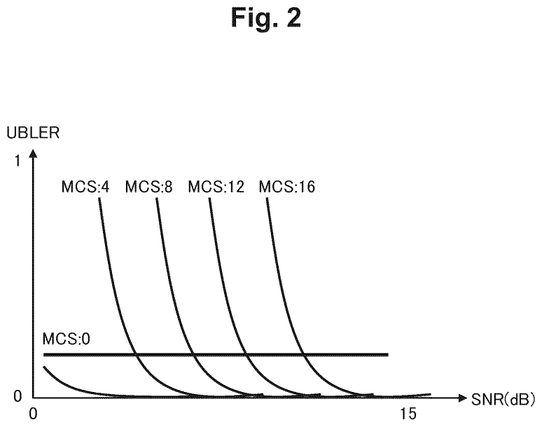

FIG. 2 shows a chart (Uplink BLER as a function of SNR) indicating a UBLER of Uplink, having a CRC check resulted in error depending on a combination of an SNR and a current MCS Index.

As illustrated in FIG. 2, the UBLER, having a CRC check resulted in error, varies depending on the combination of the SNR and the current MCS Index.

Using UBLER=1 in FIG. 2 as a reference, an MCS index satisfying “UBLER<0.1” is selected.

When the SNR is low, the UBLER tends to be high, so that the MCS needs to be decreased to make the UBLER equal to or less than 0.1. When the SNR is high, the UBLER tends to be low, so that the MCS may be increased within a range where the UBLER is equal to or less than 0.1, to increase the amount of transmitting information (spectral efficiency).

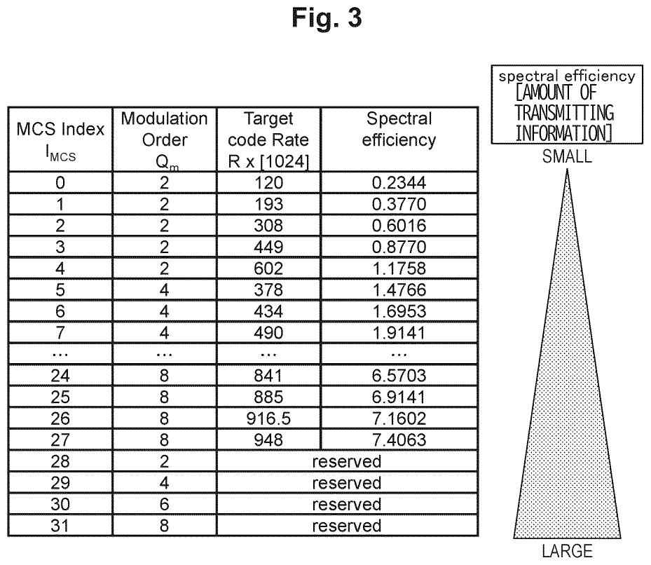

FIG. 3 shows a table of combinations for selecting an MCS Index based on an SNR and a UBLER in FIG. 2.

The MCS Index is made by indexing a possible combination of a Modulation order and a Target code rate. Specifying the MCS Index results in determining a Modulation order, a Target code rate, and a Spectral efficiency (amount of transmitting information). For example, in the case of “MCS: 0,” the values of the Modulation order and the Target code rate are small, and the Spectral efficiency is also the smallest.

The MCS Index is selected according to a radio wave condition and a block error rate (BLER) notified from the UE through data center interconnection (DCI).

### (Operation Overview)

Operation of the communication control device 100 of the wireless access system 1000 configured as described above is described below.

In the present invention, the time of FEC decoding, other demodulation processing, and the like varies depending on the MCS Index (setting of modulation and demodulation and data redundancy) and the SINR (signal-to-interference noise ratio), so that the PHY-high processing time needs to be learned in advance, on the basis of the MCS Index and the SINR.

During operation, the PHY-high processing time is estimated based on the MCS Index and the SINR, and the estimated time is determined not to reach the processing time limit of the timeslot, setting on performance of the CPU frequency or the accelerator is lowered to save power.

In a case where the CPU frequency has been excessively lowered to have the processing not completed within the timeslot, the learned content is corrected to cause the device to run thereafter with a higher frequency.

The present invention is directed to a data processing channel of a physical downlink shared channel (PDSCH) or a physical uplink shared channel (PUSCH) among channels processed by the defined PHY. Note that processing of the PHY is described in Non-Patent Literature 1.

### <Pre-Learning>

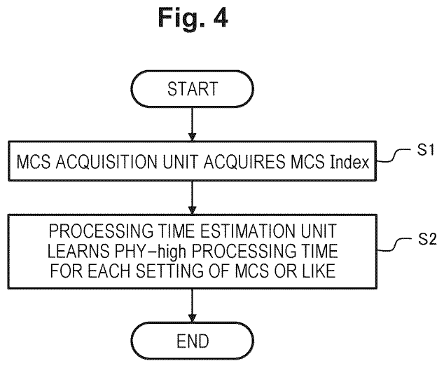

FIG. 4 shows a flowchart of an overview of learning of a PHY-high processing time based on an MCS Index.

As illustrated in FIG. 4, in step S1, the MCS acquisition unit 111 (FIG. 1) acquires an MCS Index from the MAC unit 122 of the signal processing unit 120.

In step S2, the processing time estimation unit 113 (FIG. 1) learns processing time of the PHY-high for each setting of the MCS or the like and the processing of this flow ends.

FIG. 5 shows a study results table of the PHY-high processing time for each setting of the MCS. In FIG. 5, the rows each indicate the MCS Index and the columns each indicate the CPU frequency (GHz), with an estimated value of the PHY-high processing time (us) for a set of the row and column. The value as the PHY-high processing time (us) is not a measured value but an estimated value when the row and the column are determined.

A shaded portion of the study results table in FIG. 5 indicates a selectable CPU-frequency range where the CPU frequency can be lowered. That is, the CPU frequency is set within a range in which the estimated value of the PHY-high processing time (us) in FIG. 5 falls within the PHY-high processing time (here, a limit of 500 μs to complete processing by the PHY-high).

For example, as indicated by an arrow in FIG. 5, when the MCS Index is MCS3, the estimated value of the PHY-high processing time falls within 500 μs for the CPU frequency equal to or more than 1.2 (GHz), and thus said CPU frequency can be set. In addition, among the settable CPU frequencies of 1.2 (GHz) to 2.4 (GHz), the CPU frequency is set to 1.2 (GHz) (the lowest frequency in this case) from the viewpoint of lowering the CPU frequency as much as possible.

Similarly, when the MCS Index is MCS4, the CPU frequency of 1.4 (GHz) (the lowest frequency in this case), as a result of lowering the CPU frequency as much as possible, is set from among the settable CPU frequencies of 1.4 (GHz) to 2.4 (GHz) at which the estimated value of the PHY-high processing time falls within 500 μs.

When the MCS Index is one of MCSO to MCS2, the estimated values at all the CPU frequencies of 1.0 (GHz) to 2.4 (GHz) fall within 500 μs. Therefore, the CPU frequency of 1.0 (GHz) is set to lower the CPU frequency as much as possible.

As illustrated in FIG. 5, the larger the indicator value of the MCS Index is, the larger the estimated value of the PHY-high processing time (us) is and the higher the settable CPU frequency is.

Here, the study results table of the PHY-high processing time illustrated in FIG. 5 is an important index when the frequency control unit 114 performs control to lower the CPU frequency, within a range where a value is equal to or less than a processing time of a timeslot. There should be no case where the CPU frequency is excessively lowered to have the processing not completed within the timeslot (in this case, a retransmission request may be executed to cause a delay). Therefore, in the present embodiment, actions are taken in which (1) the CPU frequency is determined in consideration of a safety factor for the set CPU frequency (including a case where a study results table is produced with the safety factor taken into account in advance), and (2) the processing time estimation unit 113 executes feedback of rewriting the table value in the study results table illustrated in FIG. 5 on the basis of an actual measurement value of the PHY-high processing time (“the learned content is corrected to cause the device to run thereafter with a higher frequency”).

As described above, the MCS acquisition unit 111 acquires the PHY-high processing time for each setting of the MCS or the like in advance, and the processing time estimation unit 113 learns the PHY-high processing time for each setting of the MCS or the like acquired in advance.

### <During Operation>

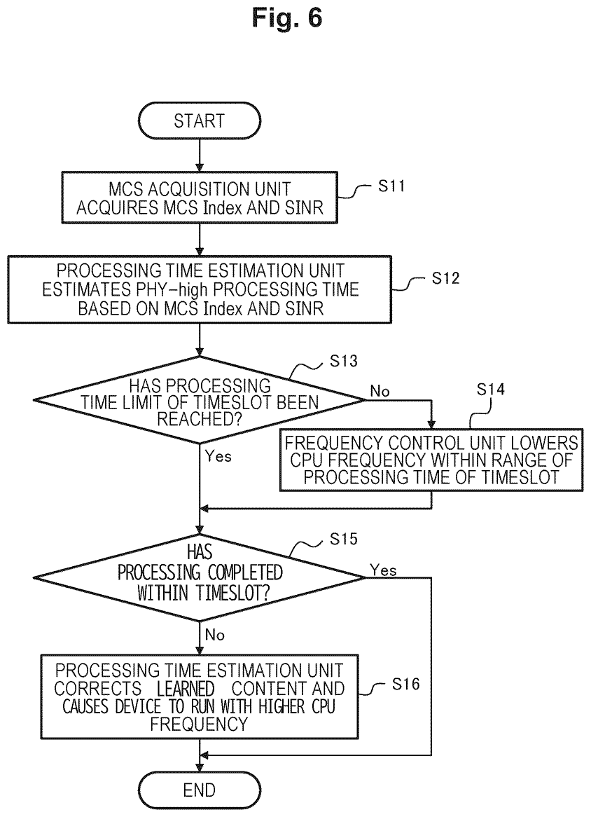

FIG. 6 shows a flowchart of a process of setting the CPU frequency, during operation, to estimate a PHY-high processing time based on an MCS Index and a SINR and lower a setting on performance of a CPU frequency.

In step S11, the MCS acquisition unit 111 acquires the MCS Index and the SINR (radio wave quality information).

In step S12, the processing time estimation unit 113 estimates the PHY-high processing time based on the MCS Index and the SINR.

In step S13, the processing time estimation unit 113 determines whether the processing time limit of the timeslot has been reached.

If the processing time limit of the timeslot has not been reached (S13: No), the processing proceeds to step S14, and if the processing time limit of the timeslot has been reached (S13: Yes), the processing proceeds to step S15.

In step S14, the frequency control unit 114 lowers the CPU frequency within the range of the processing time of the timeslot, and proceeds to step S15.

In step S15, the processing time estimation unit 113 determines whether or not the processing has been completed within the timeslot, and ends the processing of this flow if the processing has been completed within the timeslot (S15: Yes).

If the processing has not been completed within the timeslot (S15: No), the processing time estimation unit 113 in step S16 corrects the learned content to cause the device to run with a higher CPU frequency, and ends the processing of this flow.

As described above, during operation, the processing time estimation unit 113 estimates the PHY-high processing time based on the MCS Index and the SINR, and when the estimated time is determined not to reach the processing time limit of the timeslot, lowers the setting on performance of the CPU frequency to save power. In a case where the CPU frequency has been excessively lowered to have the processing not completed within the timeslot, the processing time estimation unit 113 corrects the learned content to cause the device to run thereafter with a higher frequency.

### Operation of Units

### <First Essential Point>

### (Case of Acquiring MCS Index and Estimating PHY-High Processing Time Based on MCS Index)

Hereinafter, operation of the units are described for each essential point of the present invention.

A first essential point is power saving by determining the CPU core frequency based on decoding time estimation.

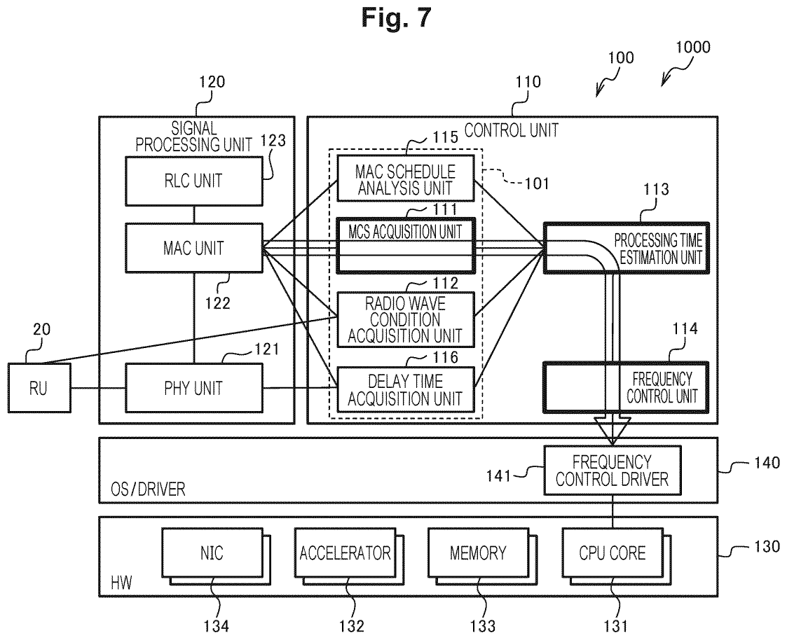

FIG. 7 illustrates operation of the first essential point of the wireless access system in FIG. 1. The functional blocks corresponding to the operation of the first essential point is indicated by thick solid lines, and the flow of the operation is indicated by an open arrow (hereinafter, the same notation is used in the drawings).

As illustrated in FIG. 7, the MCS acquisition unit 111 acquires an MCS Index from the MAC unit 122 of the signal processing unit 120.

The processing time estimation unit 113 estimates a future PHY-high processing time based on the MCS Index acquired by the MCS acquisition unit 111, and derives a settable CPU frequency.

The frequency control unit 114 determines the CPU frequency on the basis of the information from the processing time estimation unit 113, and controls the frequency control driver 141 to dynamically change the operation frequency of the CPU core 131.

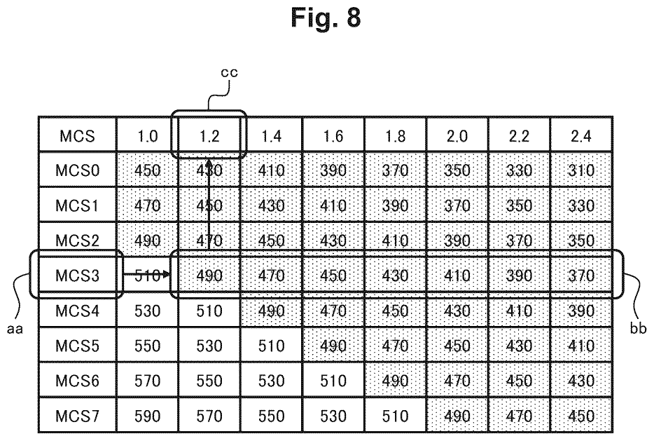

FIG. 8 illustrates using the MCS Index acquired by the MCS acquisition unit 111 to derive a settable CPU frequency based on estimation of a future PHY-high processing time. In FIG. 8, the rows each indicates the MCS Index, and the columns each indicates the CPU frequency (GHz), with an estimated value of the PHY-high processing time (us) for a set of the row and column. A shaded portion of the study results table in FIG. 8 indicates a selectable CPU-frequency range where the CPU frequency can be lowered (hereinafter, the same notation is used in the corresponding drawings).

The MCS acquisition unit 111 acquires an MCS Index from the MAC unit 122. Here, as indicated by a reference sign “aa” in FIG. 8, the MCS acquisition unit 111 acquires MCS3 of the MCS Index.

As indicated by a reference sign “bb” in FIG. 8, the processing time estimation unit 113 estimates a PHY-high processing time for each frequency based on the MCS Index acquired by the MCS acquisition unit 111. Here, the PHY-high processing times of “490”, “470”, “450”, “430”, “410”, “390”, and “370” are estimated for respective frequencies with MCS3.

As indicated by a reference sign “cc” in FIG. 8, the frequency control unit 114 determines a CPU frequency (here, determines a CPU frequency of 1.2 GHz) and executes the CPU frequency setting control. In this case, the frequency control unit 114 determines the CPU frequency of “1.2”, at which the processing is completed just barely within the timeslot, from among the CPU frequencies of “1.2”, “1.4”, “1.6”, “1.8”, “2.0”, “2.2”, and “2.4” corresponding to the PHY-high processing times of “490”, “470”, “450”, “430”, “410”, “390”, and “370”. Power saving can be achieved by lowering the CPU frequency so that the processing is completed just barely within the timeslot.

### (Case of Acquiring Radio Wave Quality Information and Estimating PHY-High Processing Time Based on Radio Wave Quality Information)

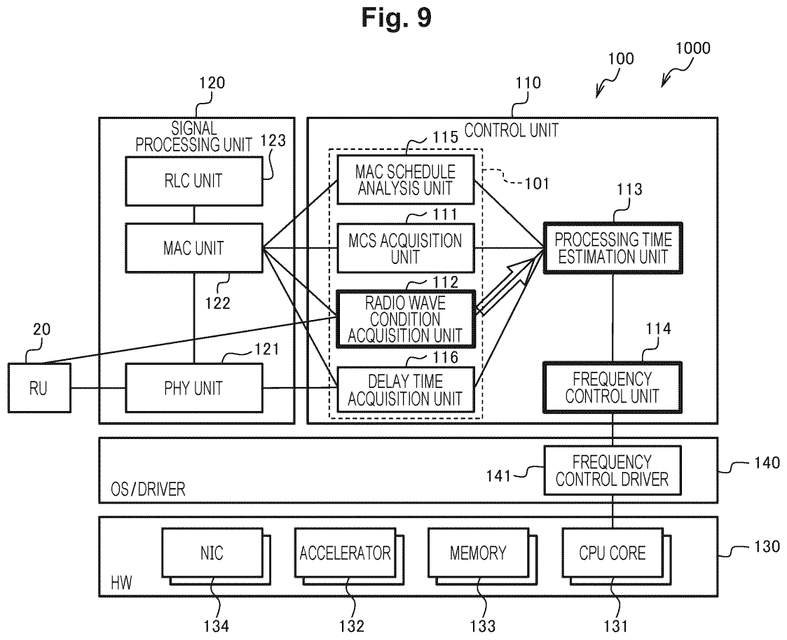

FIG. 9 illustrates operation of the first essential point of the wireless access system in FIG. 1.

As illustrated in FIG. 9, the radio wave condition acquisition unit 112 acquires the radio wave quality information from the MAC unit 122 or the RU 20.

The processing time estimation unit 113 estimates a future PHY-high processing time based on the radio wave quality information acquired by the radio wave condition acquisition unit 112, and derives a settable CPU frequency.

The frequency control unit 114 determines the CPU frequency on the basis of the information from the processing time estimation unit 113, and controls the frequency control driver 141 to dynamically change the operation frequency of the CPU core 131.

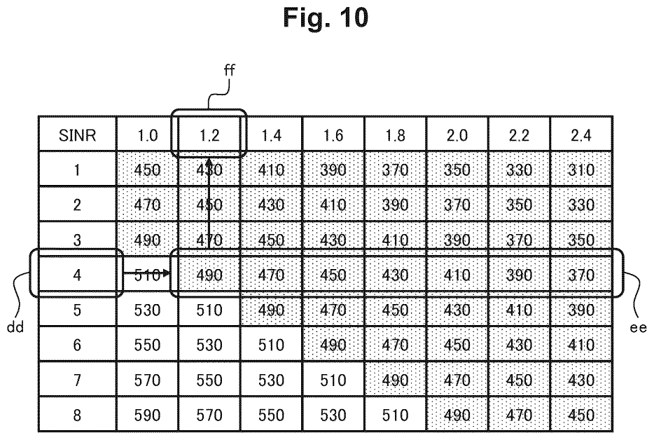

FIG. 10 illustrates using the radio wave quality information acquired by the radio wave condition acquisition unit 112 to derive a settable CPU frequency based on estimation of a future PHY-high processing time. In FIG. 10, the rows each v indicates the SINR, and the columns each indicates the CPU frequency (GHz), with the PHY-high processing time (us) for a set of the row and column. A shaded portion of the study results table in FIG. 10 indicates a selectable CPU-frequency range where the CPU frequency can be lowered.

As indicated by a reference sign “dd” in FIG. 10, the radio wave condition acquisition unit 112 acquires the radio wave quality information acquired from the MAC unit 122 or the RU 20. Here, the radio wave condition acquisition unit 112 acquires SINR4.

As indicated by a reference sign “ee” in FIG. 10, the processing time estimation unit 113 estimates a PHY-high processing time for each frequency based on the radio wave quality information acquired by the radio wave condition acquisition unit 112. Here, the PHY-high processing times of “490”, “470”, “450”, “430”, “410”, “390”, and “370” are estimated for respective frequencies with SINR4.

As indicated by a reference sign “ff” in FIG. 10, the frequency control unit 114 determines a CPU frequency (here, determines a CPU frequency of 1.2 GHz) and executes the CPU frequency setting control. In this case, the frequency control unit 114 determines the CPU frequency of “1.2”, at which the processing is completed just barely within the timeslot, from among the CPU frequencies of “1.2”, “1.4”, “1.6”, “1.8”, “2.0”, “2.2”, and “2.4” corresponding to the PHY-high processing times of “490”, “470”, “450”, “430”, “410”, “390”, and “370”. Power saving can be achieved by lowering the CPU frequency so that the processing is completed just barely within the timeslot.

The case of acquiring an MCS Index and estimating the PHY-high processing time based on the MCS Index and the case of acquiring radio wave quality information and estimating the PHY-high processing time based on the radio wave quality information have been described above, and the processing time estimation may be performed based on only one of the MCS Index and the radio wave quality information. Alternatively, both the MCS Index and the radio wave quality information may be used to produce three-dimensional mapping, for example, and to improve accuracy of estimating the processing time with reference to this map.

### <Second Essential Point>

A second essential point is improving accuracy of CPU control and power saving through analysis of MAC schedule.

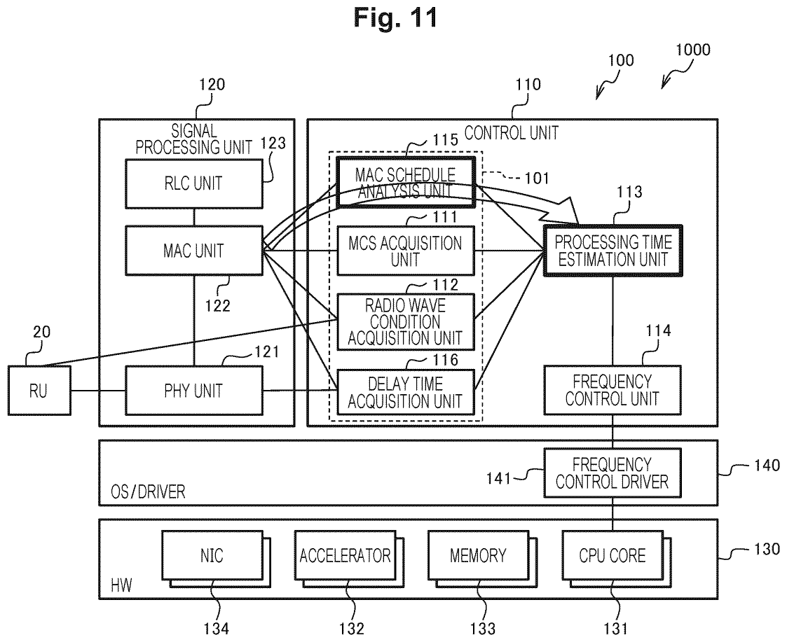

FIG. 11 illustrates operation of the second essential point of the wireless access system in FIG. 1.

As illustrated in FIG. 11, the MAC schedule analysis unit 115 acquires radio resource arrangement information (MAC schedule information) from the MAC unit 122 of the signal processing unit 120 and converts the information into resource arrangement information (PHY schedule information) in the PHY-high.

Based on the PHY schedule information, the processing time estimation unit 113 estimates the processing time of each PHY timeslots for respective situations of both UL and DL directions, only UL, only DL, and none in any directions.

As a result, accuracy improvement in both directions in consideration of DL processing and further power saving in the PHY timeslot that does not require handling can be achieved.

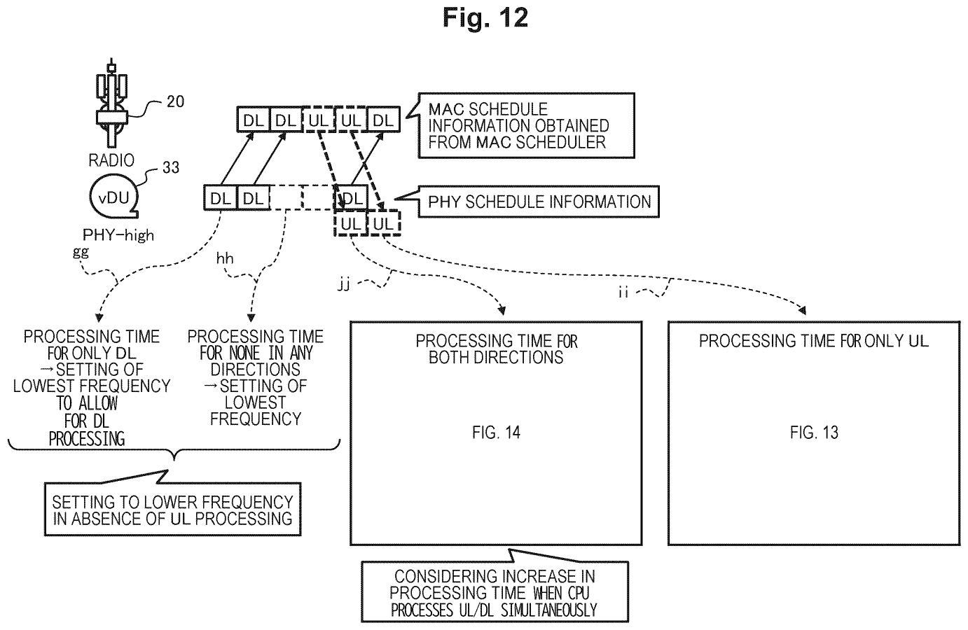

FIG. 12 illustrates processing for each timeslot of downlink data processing (DL) to transmit data from the vDU, as the DU server, to the RU 20 and uplink data processing (UL) to transmit data from the RU 20 to the vDU, as the DU server, in the wireless access system in FIG. 11.

The timeslot of the RU 20 has MAC schedule information obtained from a MAC scheduler.

The MAC schedule analysis unit 115 acquires the MAC schedule information and converts the MAC schedule information into PHY schedule information in the PHY-high. In FIG. 12, the PHY schedule information obtained by converting the MAC schedule information is input into the timeslot of the vDU as the DU server.

As indicated by a reference sign “gg” in FIG. 12, in the case of the processing time for only DL, the processing time can be set with the lowest frequency to allow for the DL processing.

As indicated by a reference sign “hh” in FIG. 12, in the case of the processing time for none in any directions, the processing time can be set with the lowest frequency.

In the above two cases, when there is no processing for UL, a lower frequency can be set. Accordingly, further power saving can be achieved.

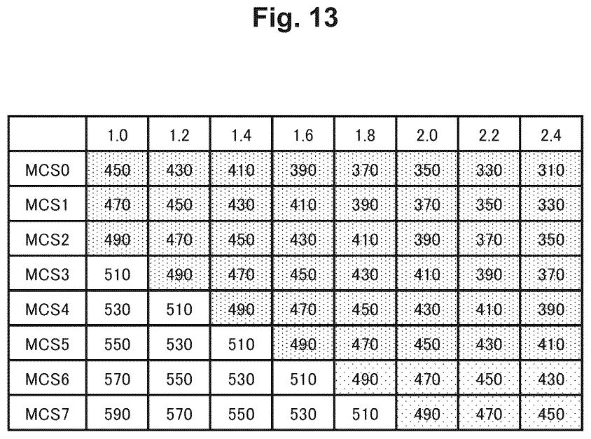

A chart illustrating the processing time for only UL is shown in FIG. 13, as indicated by a reference sign “ii”.

FIG. 13 illustrates using the MCS Index acquired by the MCS acquisition unit 111 to derive a settable CPU frequency, based on estimation of a future PHY-high processing time. In FIG. 13, the rows each indicate the MCS Index and the columns each indicate the CPU frequency (GHz), with the PHY-high processing time (us) for a set of the row and column.

Here, the study results table in FIG. 13 has the same values as those in FIG. 8.

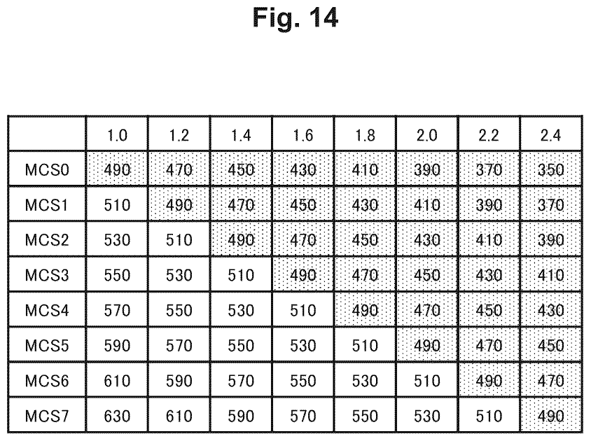

A chart illustrating the processing time for both UL and DL directions is shown in FIG. 14, as indicated by a reference sign “jj” in FIG. 12.

FIG. 14 illustrates using the MCS Index acquired by the MCS acquisition unit 111 to derive a settable CPU frequency, based on estimation of a future PHY-high processing time. In FIG. 14, the rows each indicate the MCS Index and the columns each indicate the PHY-high processing time (us) for a set of the row and column.

Here, the study results table in FIG. 14 is different from that in FIG. 13 on values and ranges in which the CPU frequency can be lowered.

The study results table itself is switched when the CPU processes the UL/DL simultaneously, in consideration of an increase in processing time. As a result, accuracy can be improved by preparing an appropriate study results table.

### <Third Essential Point>

A third essential point is improving accuracy of CPU control through feedback of delay time.

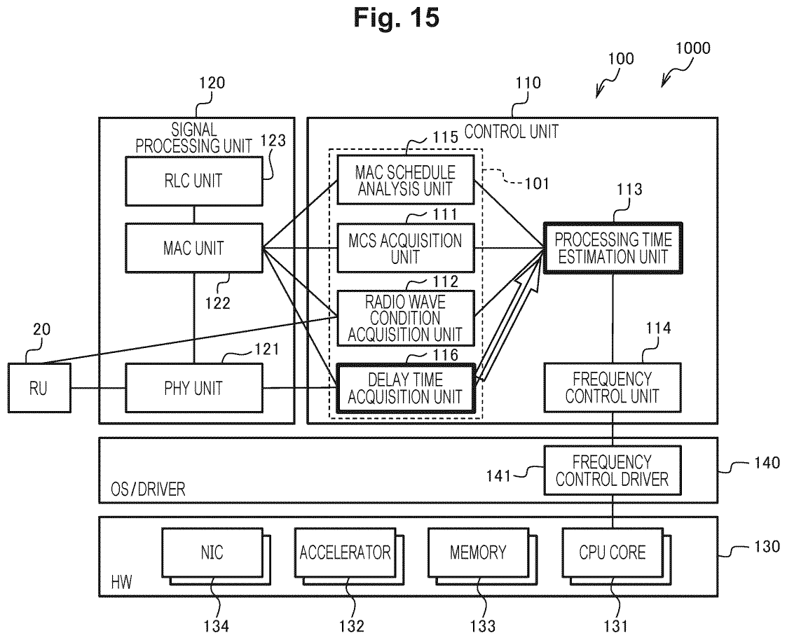

FIG. 15 illustrates operation of a third essential point of the wireless access system in FIG. 1.

As illustrated in FIG. 15, the delay time acquisition unit 116 acquires an actual PHY-high processing time from the PHY unit 121 of the signal processing unit 120 and provides the actual PHY-high processing time to the processing time estimation unit 113.

The processing time estimation unit 113 rewrites the table value of the study results table, based on the PHY-high processing time provided from the delay time acquisition unit 116 (modify the way of estimation).

Here, the delay time acquisition unit 116 may additionally acquire the presence or absence of a retransmission request from the MAC unit 122 and provide the presence or absence to the processing time estimation unit 113. Acquiring the presence or absence of a retransmission request allows for taking time required for processing a retransmission request, if any, into consideration and adding the time to the PHY-high processing time.

As described above, accuracy of the CPU control can be improved through the feedback (on actual PHY-high processing time and/or presence or absence of retransmission request) in consideration of the server operation status.

Hereinafter, a specific example of feedback on the delay time, as the third essential point, will be described.

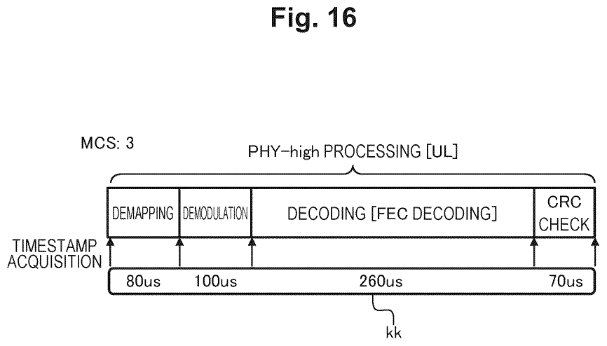

FIG. 16 illustrates a timeslot of PHY-high processing (UL) for MCS: 3. The upper bar chart in FIG. 16 illustrates breakdown of a timeslot of the PHY-high processing, and the lower bar chart in FIG. 16 illustrates processing times (us) of the PHY-high processing, that is, 80 (us) for demapping, 100 (us) for demodulation 100, 260 (us) for decoding (FEC decoding), and 70 (us) for CRC check 70. Therefore, the PHY-high processing time is 510 (us) (see a reference sign “kk” in FIG. 16).

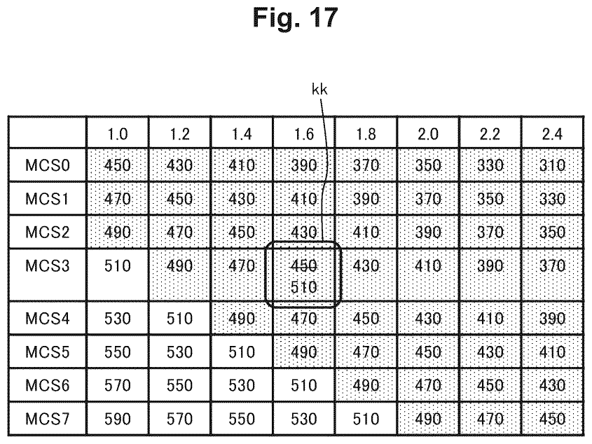

FIG. 17 illustrates an example of rewriting a table value of the study results table, based on the PHY-high processing time in FIG. 16. In FIG. 17, the study results table before rewriting is that in FIG. 13.

As indicated by the reference sign “kk” in FIG. 17, the processing time estimation unit 113 rewrites the original table value of 450, as the PHY-high processing time for MCS: 3, to 510.

By feeding back the actual PHY-high processing time and rewriting the table value of the study results table, the optimum CPU frequency can be set to improve accuracy of the CPU control.

### [Examples of Tables]

Example of tables included in the control unit 110 of the communication control device 100 in the wireless access system 1000 in FIG. 1 will be described.

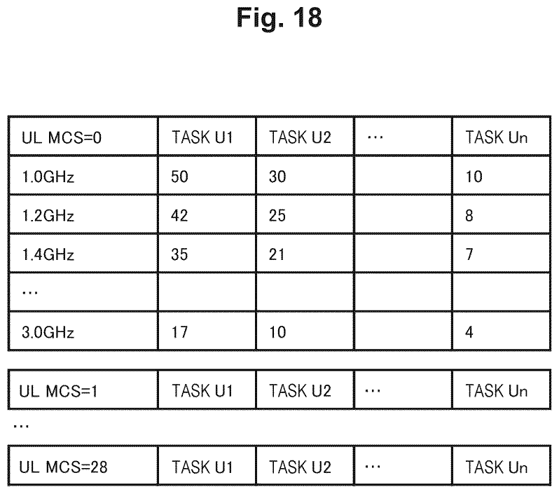

FIG. 18 shows an example of a table of a mixed DB used for the processing time in FIG. 14 for communication in both directions. This mixed DB exists for each UL MCS.

The processing time estimation unit 113 reads/writes the mixed DB. The processing time estimation unit 113 reads an estimated value of processing time by the UL task at the CPU frequency when data for UL and DL exists.

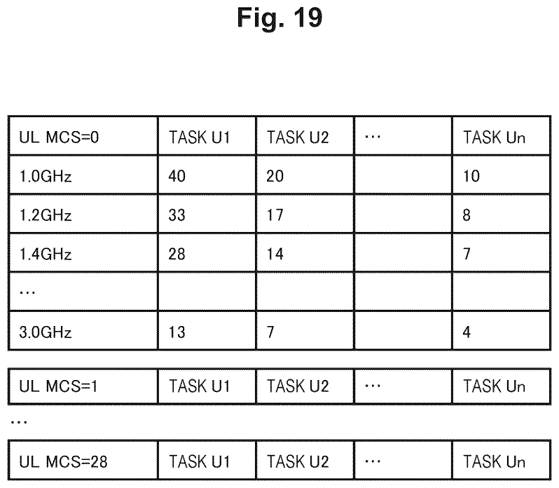

FIG. 19 shows an example of a table of the UL DB used for the processing time for only UL in FIG. 13. This UL DB exists for each UL MCS.

The processing time estimation unit 113 reads/writes the UL DB. The processing time estimation unit 113 reads an estimated value of processing time by the UL task at the CPU frequency when data for only UL exists.

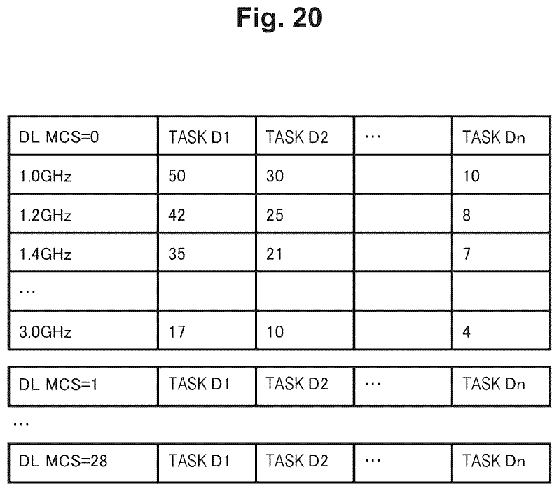

FIG. 20 shows an example of a table of the DL DB. This DL DB exists for each DL MCS. The processing time estimation unit 113 reads/writes the DL DB. The processing time estimation unit 113 reads an estimated value of processing time by the DL task at the CPU frequency when DL data exists.

As described above, the DBs in FIGS. 18 to 20 store time values by MCS for the tasks, and the processing time estimation unit 113 finally adds up the time values for the tasks to calculate the processing time by MCS. The processing time estimation unit 113 feeds back the added-up processing time by MCS and rewrites the table value of the study results table.

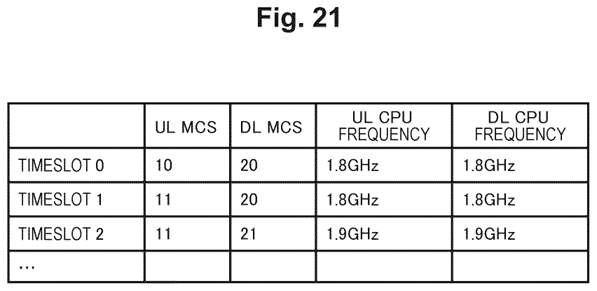

FIG. 21 shows a CPU frequency setting history table storing, UL MCS, DL MCS, UL CPU frequency, and DL CPU frequency for each timeslot.

The CPU frequency setting history table is read by the processing time estimation unit 113 and written by the frequency control unit 114.

The CPU frequency setting history table is used to keep records of the MCS Index and the CPU frequency for the past PHY timeslot, for use at the time of feedback.

(1) When the UL/DL tasks are loaded onto all over the controlled CPU cores 131, the UL CPU frequency equals to the DL CPU frequency.

(2) When the UL/DL tasks are respectively loaded onto different CPU cores 131, the UL CPU frequency is not equal to the DL CPU frequency.

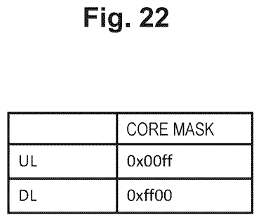

FIG. 22 is a control target table and stores UL/DL core masks.

The control target table is read by the processing time estimation unit 113 and the frequency control unit 114. Note that the core mask is only to be read, but not written.

The processing time estimation unit 113 and the frequency control unit 114 designate in advance the core masks for the CPUs to run the UL and DL tasks, respectively.

(1) When the UL/DL tasks are loaded onto all over the controlled CPU cores 131, the UL core mask equals the DL core mask.

(2) When the UL/DL tasks are respectively loaded onto different CPU cores 131, the UL core mask and the DL core mask are mutually exclusive (cores are functionally separated from each other).

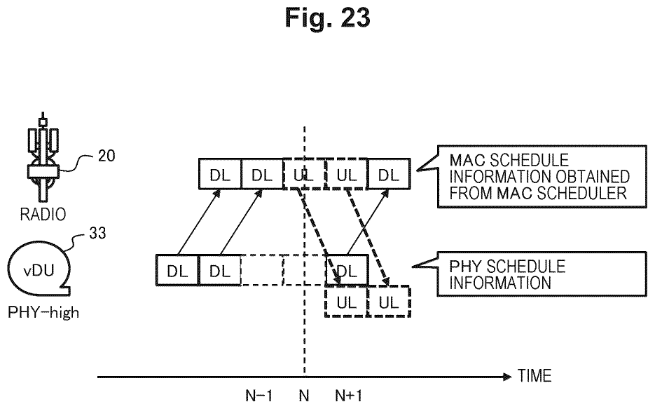

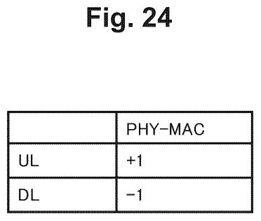

FIG. 23 illustrates handling of timeslots, based on the time axis, for downlink data processing (DL) to transmit data from the vDU, as the DU server, to the RU 20 and uplink data processing (UL) to transmit data from the RU 20 to the vDU, as the DU server, in order to interpret a MAC-PHY conversion table in FIG. 24.

The timeslot for the RU 20 has MAC schedule information obtained from an MAC scheduler.

The MAC schedule analysis unit 115 acquires the MAC schedule information and converts the MAC schedule information into PHY schedule information for the PHY-high. In FIG. 23, the PHY schedule information obtained by converting the MAC schedule information is input into the timeslot for the vDU as the DU server.

When the central timeslot among the timeslots for UL by the RU 20 in FIG. 23 is at N on the time axis, the timing of the previous timeslot is N−1, and the timing of the next timeslot is N+1.

FIG. 24 is an example of the MAC-PHY conversion table. The MAC-PHY conversion table in FIG. 24 is referred to when the MAC schedule information is converted into the PHY schedule information.

The MAC-PHY conversion table is read by the processing time estimation unit 113 and the delay time acquisition unit 116 and written by the MAC schedule analysis unit 115.

The processing time estimation unit 113 refers to the MAC-PHY conversion table to convert the MAC schedule information into the PHY schedule information. The PHY timeslot and the MAC timeslot have the relationship described below.

$$P H Y timeslot = M A C timeslot + ( P H Y - M A C )$$

### [Changing Granularity in Controlling CPU Frequency]

Changing granularity in controlling the CPU frequency will be described.

Granularity in controlling the CPU frequency can be changed by the way of distributing UL/DL tasks to the CPU cores.

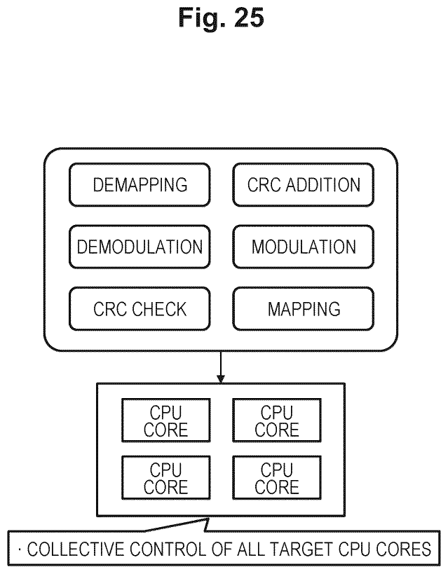

FIG. 25 shows an example configuration of the DU server in a case where UL/DL tasks are loaded onto all over the controlled CPU cores.

In a case where the UL/DL tasks are loaded onto all over the controlled CPU cores, the DU server collectively controls all the controlled CPU cores 131.

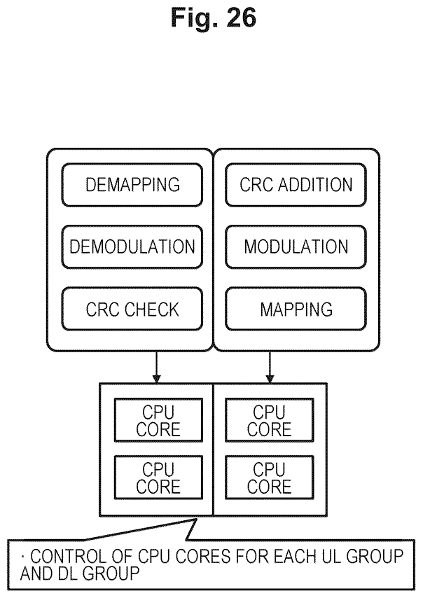

FIG. 26 shows an example configuration of the DU server in a case where UL/DL tasks are respectively loaded onto different CPU cores.

When UL/DL tasks are respectively loaded onto different CPU cores, the DU server respectively controls the CPU cores for UL group and DL group. In the case of FIG. 26, the CPU core (left side in FIG. 26) to process demapping, demodulation, and CRC check for the UL group is separated from the CPU core (right side in FIG. 26) to process CRC addition, modulation, and mapping for the DL group.

In this manner, granularity in controlling the CPU frequency is changed by the way of distributing UL/DL tasks to CPU cores.

### [Estimation of Processing Time by PHY-High for DL]

Estimation of processing time by the PHY-high for DL will be described.

When the processing time for DL varies depending on the DL MCS or DL radio wave information, processing time by the PHY-high for DL can also be estimated. In this case, the control target is the CPU core for DL operation. The CPU core for UL operation is controlled based on a result of estimating processing time by the PHY-high for UL.

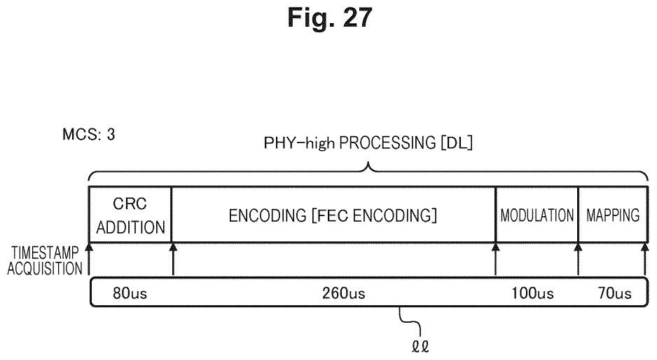

FIG. 27 illustrates a timeslot of PHY-high processing (DL) for MCS: 3. The upper bar chart in FIG. 27 illustrates breakdown of a timeslot of the PHY-high processing, and the lower bar chart in FIG. 27 illustrates processing times (us) of the PHY-high processing, that is, 80 (us) for CRC addition, 260 (us) for encoding (FEC encoding), 100 (us) for modulation), and 70 (us) for mapping. Therefore, the PHY-high processing time is 510 (us) (see a reference sign “11” in FIG. 27).

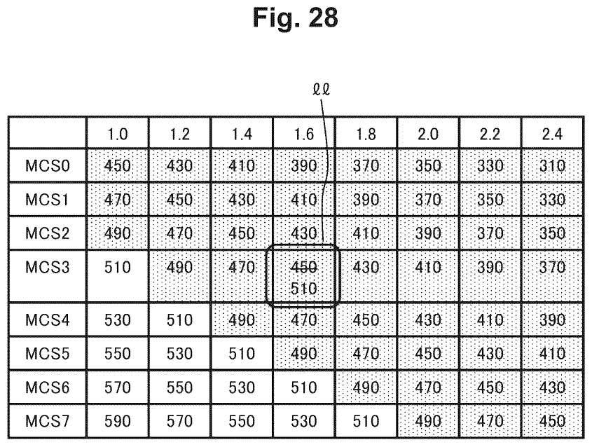

FIG. 28 illustrates an example of rewriting a table value of the study results table, based on the PHY-high processing time in FIG. 27. In FIG. 28, the study results table before rewriting is that in FIG. 13.

As indicated by the reference sign “ll” in FIG. 28, the processing time estimation unit 113 rewrites the original table value of 450, as the PHY-high processing time for MCS: 3, to 510.

By estimating the PHY-high time for DL and rewriting the table value of the study results table, accuracy of controlling the CPU can be improved when the processing time for DL varies depending on the DL MCS or the DL radio wave information.

### [Flowchart of Estimating Processing Time]

### <Overall Flow of Estimating Processing Time>

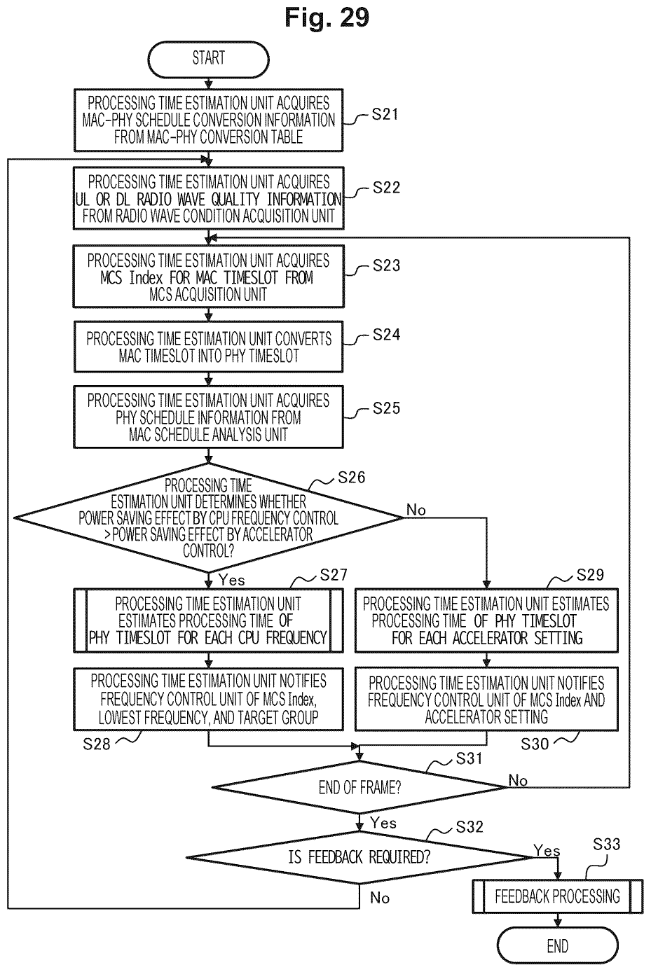

Hereinafter, a process of estimating the processing time by the processing time estimation unit 113 will be described with reference to flowcharts in FIGS. 29 to 31.

FIG. 29 shows a flowchart of process of estimating processing time by the processing time estimation unit 113.

In step S21, the processing time estimation unit 113 (FIG. 1) acquires MAC-PHY schedule conversion information from the MAC-PHY conversion table (FIG. 24).

In step S22, the processing time estimation unit 113 acquires the UL or DL radio wave quality information from the radio wave condition acquisition unit 112.

In step S23, the processing time estimation unit 113 acquires the MCS Index for the MAC timeslot from the MCS acquisition unit 111.

In step S24, the processing time estimation unit 113 converts the MAC timeslot into the PHY timeslot. The conversion from the MAC timeslot to the PHY timeslot has been described with reference to FIGS. 23 and 24.

In step S25, the processing time estimation unit 113 acquires PHY schedule information from the MAC schedule analysis unit 115 (FIG. 1).

In step S26, the processing time estimation unit 113 determines whether the power saving effect by the CPU frequency control is larger than the power saving effect by the accelerator control (power saving effect by CPU frequency control>power saving effect by accelerator control).

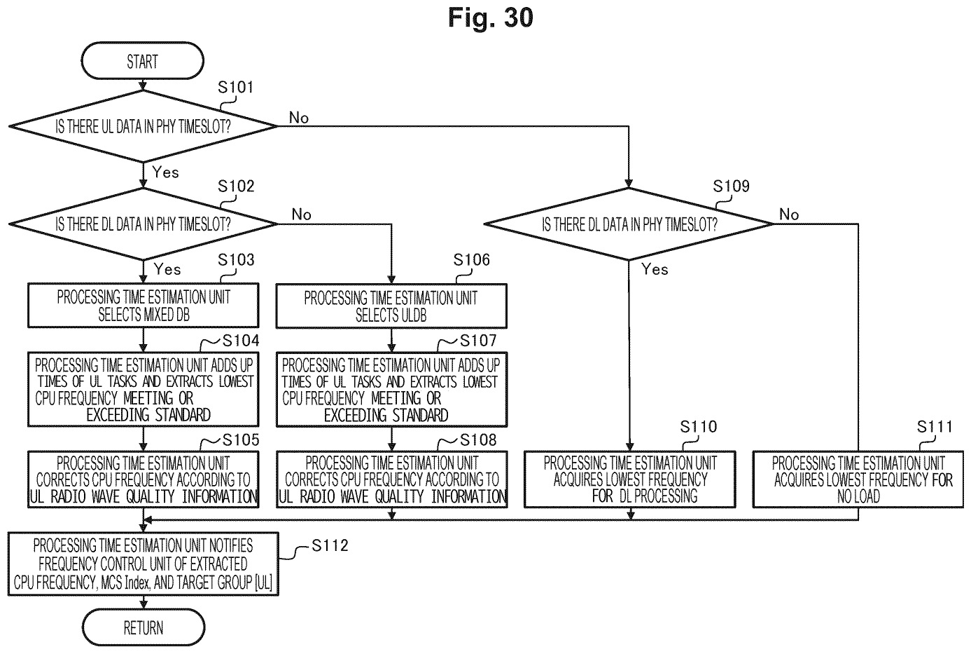

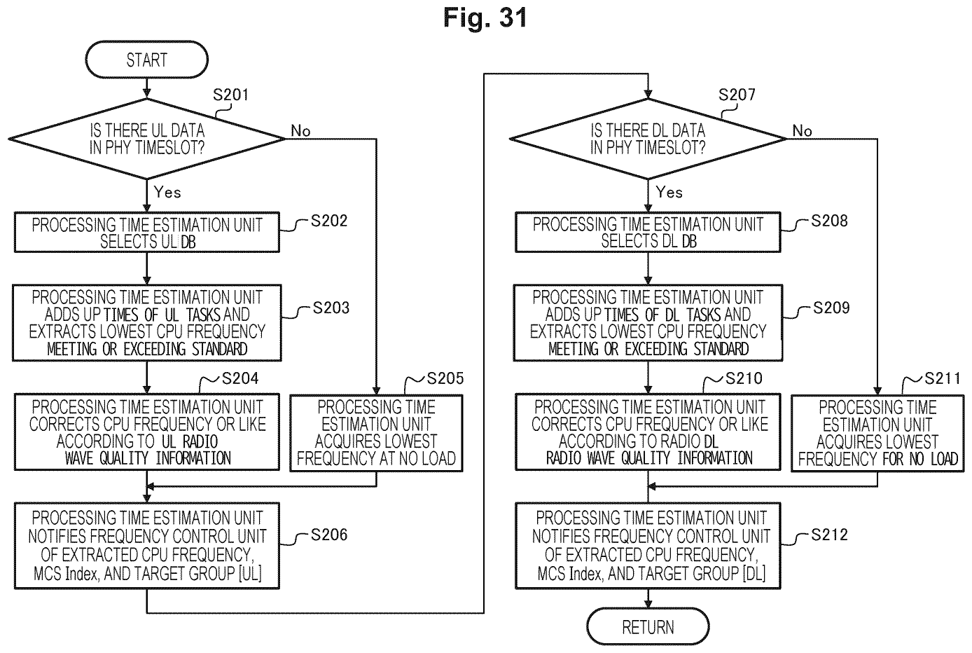

If the power saving effect by the CPU frequency control is larger than the power saving effect by the accelerator control (S26: Yes), the processing time estimation unit 113 in step S27 estimates the processing time of the PHY timeslot for each CPU frequency. Note that details of estimating the processing time for each frequency will be described below with reference to FIGS. 30 and 31.

In step S28, the processing time estimation unit 113 notifies the frequency control unit 114 of the MCS Index, the lowest frequency, and the target group, and proceeds to step S31.

On the other hand, if the power saving effect by the CPU frequency control is equal to or less than the power saving effect by the accelerator control (S26: No) in step S26, the processing time estimation unit 113 in step S29 estimates the processing time of the PHY timeslot for each accelerator setting.

In step S30, the processing time estimation unit 113 notifies the frequency control unit 114 of the MCS Index and the accelerator setting, and proceeds to step S31.

In step S31, the processing time estimation unit 113 determines whether the end of the frame of the data in processing has been reached, and if the end of the frame has not been reached (S31: No), returns to step S23 and repeats the processing of steps S23 to S30.

If the end of the frame has been reached (S31: Yes), the processing time estimation unit 113 in step S32 determines whether or not feedback is required (whether or not being in a mode to execute feedback control/whether or not being under a feedback control condition).

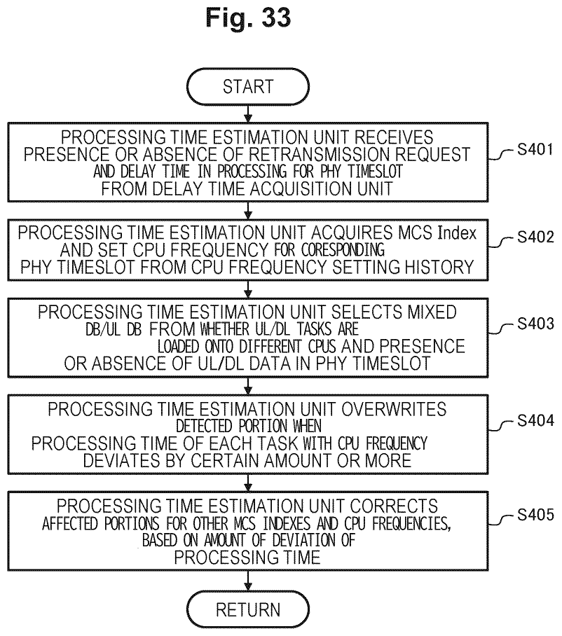

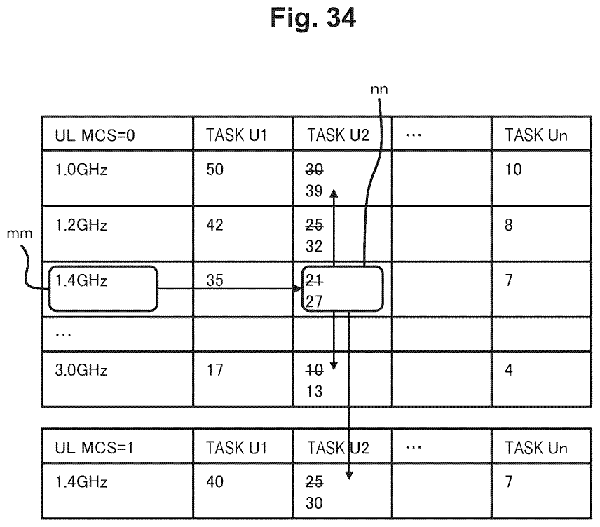

If feedback is required (S32: Yes), the feedback processing is executed in step S33, and the processing of the flow ends. Note that details of the feedback processing will be described below with reference to FIGS. 33 and 34. On the other hand, if feedback is not required (S32: No), the processing returns to step S22 and continues.

### <Detailed Flow of Estimating Processing Time>

Details of estimating the processing time will be described.

There are cases where the UL/DL tasks are loaded onto all over the controlled CPU cores (FIG. 30) and cases where the UL/DL tasks are respectively loaded onto different CPU cores (FIG. 31).

FIG. 30 shows a subroutine of the process of estimating processing time in a case where UL/DL tasks are loaded onto all over the controlled CPU cores. It is called by a subroutine call in step S27 in FIG. 29 and is then executed.

In step S101, the processing time estimation unit 113 (FIG. 1) determines whether or not there is UL data in the PHY timeslot.

If the UL data is present in the PHY timeslot (S101: Yes), the processing time estimation unit 113 in step S102 determines whether or not there is DL data in the PHY timeslot.

If the DL data is present in the PHY timeslot (S102: Yes), the processing time estimation unit 113 selects the mixed DB (FIG. 18) in step S103.

In step S104, the processing time estimation unit 113 adds up times of the UL tasks and selects the lowest CPU frequency meeting or exceeding the standard. The processing time estimation unit 113 also selects the accelerator setting.

In step S105, the processing time estimation unit 113 corrects the CPU frequency according to the UL radio wave quality information, and proceeds to step S112. The CPU frequency correction increases the CPU frequency on the assumption that the processing time becomes longer when the radio wave quality is poor.

If there is no DL data in the PHY timeslot in step S102 (S102: No), the processing time estimation unit 113 selects the UL DB in step S106.

In step S107, the processing time estimation unit 113 adds up times of the UL tasks and selects the lowest CPU frequency meeting or exceeding the standard. The processing time estimation unit 113 also selects the accelerator setting.

In step S108, the processing time estimation unit 113 corrects the CPU frequency according to the UL radio wave quality information, and proceeds to step S112. Here, when the radio wave quality is poor, the CPU frequency is increased on the assumption that the processing time becomes longer.

If there is no UL data in the PHY timeslot in step S101 (S101: No), the processing time estimation unit 113 in step S109 determines whether or not there is DL data in the PHY timeslot.

If there is DL data in the PHY timeslot (S109: Yes), the processing time estimation unit 113 in step S110 acquires the lowest frequency at the time of the DL processing and proceeds to step S112. The processing time estimation unit 113 also selects the accelerator setting.

If there is no DL data in the PHY timeslot in step S109 (S109: No), the processing time estimation unit 113 in step S111 acquires the lowest frequency when there is no load and proceeds to step S112. The processing time estimation unit 113 also selects the accelerator setting.

In step S112, the processing time estimation unit 113 notifies the frequency control unit 114 (FIG. 1) of the selected CPU frequency, MCS Index, and target group (UL), and returns to step S27 in FIG. 29.

FIG. 31 shows a subroutine of the process of estimating processing time in a case where UL/DL tasks are respectively loaded onto different CPU cores. It is called by a subroutine call in step S27 in FIG. 29 and is then executed.

In step S201, the processing time estimation unit 113 (FIG. 1) determines whether or not there is UL data in the PHY timeslot.

If there is UL data in the PHY timeslot (S201: Yes), the processing time estimation unit 113 selects the UL DB (FIG. 19) in step S202.

In step S203, the processing time estimation unit 113 adds up times of the UL tasks and selects the lowest CPU frequency meeting or exceeding the standard. The processing time estimation unit 113 also selects the accelerator setting.

In step S204, the processing time estimation unit 113 corrects the CPU frequency according to the UL radio wave quality information, and proceeds to step S206. The CPU frequency correction increases the CPU frequency on the assumption that the processing time becomes longer when the radio wave quality is poor.

If there is no DL data in the PHY timeslot in step S201 (S201: No), the processing time estimation unit 113 in step S205 acquires the lowest frequency when there is no load and proceeds to step S206.

In step S206, the frequency control unit 114 is notified of the selected CPU frequency, MCS Index, and target group (UL).

In step S207, the processing time estimation unit 113 determines whether or not there is DL data in the PHY timeslot.

If there is DL data in the PHY timeslot (S207: Yes), the processing time estimation unit 113 selects the DL DB in step S208.

In step S209, the processing time estimation unit 113 adds up times of the DL tasks and selects the lowest CPU frequency meeting or exceeding the standard. The processing time estimation unit 113 also selects the accelerator setting.

In step S210, the processing time estimation unit 113 corrects the CPU frequency according to the DL radio wave quality information, and proceeds to step S206. The CPU frequency correction increases the CPU frequency on the assumption that the processing time becomes longer when the radio wave quality is poor.

If there is no DL data in the PHY timeslot in step S207 (S207: No), the processing time estimation unit 113 in step S211 acquires the lowest frequency when there is no load and proceeds to step S212.

In step S212, the frequency control unit is notified of the selected CPU frequency, MCS Index, and target group (DL), and the processing returns to step S27 in FIG. 29.

Details of estimating the processing time have been described above. Next, feedback to estimating the processing time will be described.

### <Detailed Flow of Processing Feedback>

Details of processing feedback to estimating the processing time will be described.

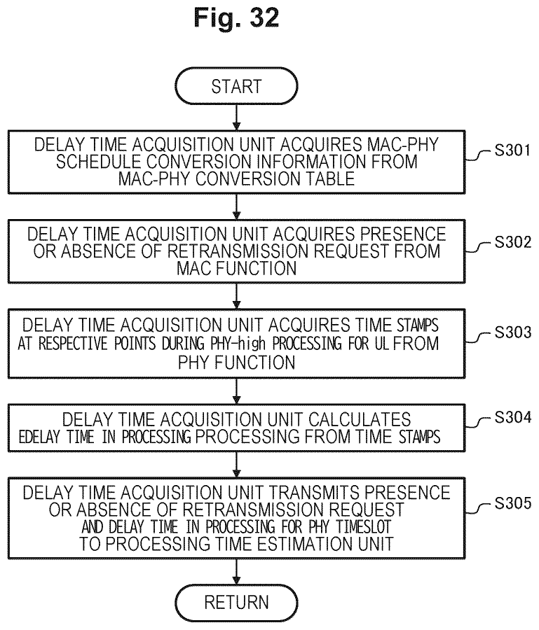

Processing feedback to estimating the processing time includes processing by the delay time acquisition unit 116 (FIG. 32) and process of estimating processing time by the processing time estimation unit 113 (FIGS. 33 and 34).

FIG. 32 shows a subroutine of feedback process to be controlled by the delay time acquisition unit 116. It is called by a subroutine call in step S33 in FIG. 29 and is then executed.

In step S301, the delay time acquisition unit 116 acquires MAC-PHY schedule conversion information from the MAC-PHY conversion table.

In step S302, the delay time acquisition unit 116 acquires the presence or absence of a retransmission request from the MAC unit 122.

In step S303, the delay time acquisition unit 116 acquires time stamps at respective points during PHY-high processing for UL from the PHY unit 121.

In step S304, the delay time acquisition unit 116 calculates the delay time in processing from the time stamps.

In step S305, the delay time acquisition unit 116 transmits the presence or absence of a retransmission request and the delay time in processing for the PHY timeslot to the processing time estimation unit, and returns to step S33 in FIG. 29.

FIG. 33 shows a subroutine of the feedback process executed by the processing time estimation unit 113 on the basis of the processing result in FIG. 32 by the delay time acquisition unit 116. It is called by a subroutine call in step S33 in FIG. 29 and is then executed.

In step S401, the processing time estimation unit 113 receives the presence or absence of a retransmission request and the delay time in processing for the PHY timeslot from the delay time acquisition unit.

In step S402, the processing time estimation unit 113 acquires the MCS Index and the selected CPU frequency for the PHY timeslot from the CPU frequency setting history.

In step S403, the processing time estimation unit 113 selects the mixed DB/UL DB, based on whether the UL/DL tasks are respectively loaded onto different CPUs and the presence or absence of the UL/DL data in the PHY timeslot. The way of selecting the mixed DB/UL DB is similar to the details of estimating the processing time in FIGS. 30 and 31.

In step S404, the processing time estimation unit 113 overwrites the detected portion when the processing time of the tasks with the CPU frequency deviates by more than a certain amount.

In step S405, the processing time estimation unit 113 corrects affected portions for other MCS Indexes and CPU frequencies, based on the amount of deviation of the processing time, and returns to step S33 in FIG. 29.

Here, the presence or absence of a retransmission request may be used to determine whether or not it is necessary to overwrite the mixed DB/UL DB/DL DB.

FIG. 34 shows an image chart of the change being cascaded to values for other MCS Indexes and CPU frequencies in tables in the UL DB in FIG. 20. This illustrates step 405 in FIG. 33.

The processing time estimation unit 113 corrects affected portions for other MCS Indexes and CPU frequencies, based on the amount of deviation of the processing time. For example, when the deviation of the processing time is found in the flow in FIG. 32, the CPU frequency of 1.4 GHz (reference sign “nn” in FIG. 34) for UL MCS=0 is located as the one in question, and the pertinent value with said frequency (reference sign “mm” of FIG. 34) is corrected.

The feedback to estimating the processing time has been described.

### [Flowchart of Controlling CPU Frequency]

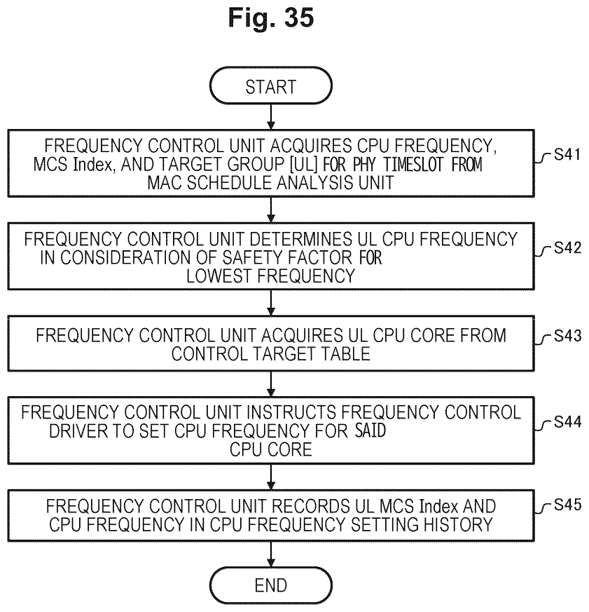

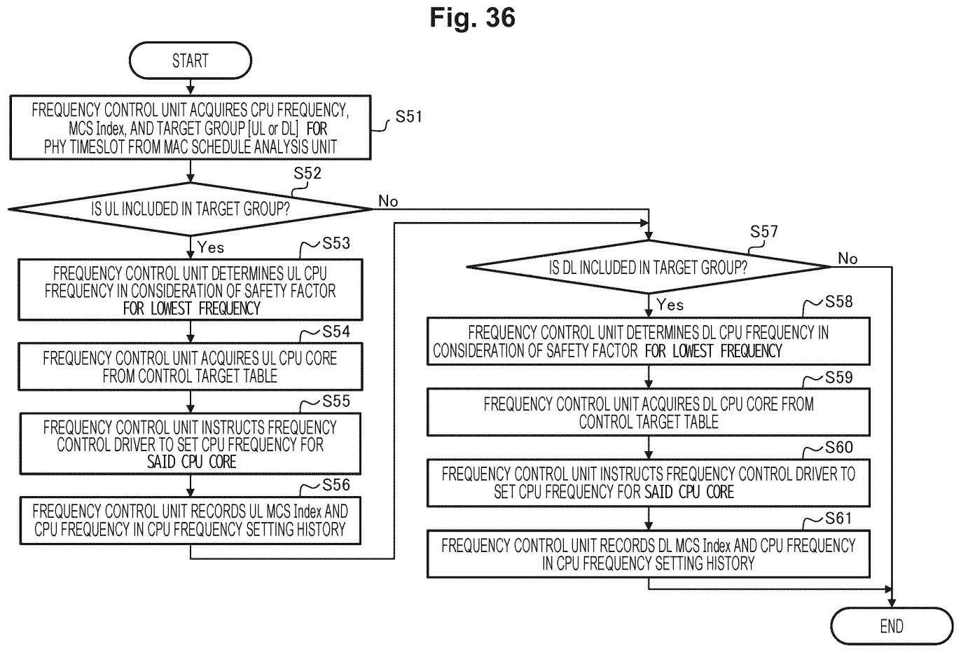

Controlling the CPU frequency includes processing in cases where the UL/DL tasks are loaded onto all over the controlled CPU cores (FIG. 35) and processing in cases where the UL/DL tasks are respectively loaded onto different CPU cores (FIG. 36).

FIG. 35 shows a flowchart of controlling the CPU frequency in cases where UL/DL tasks are loaded onto all over the controlled CPU cores.

In step S41, the frequency control unit 114 (FIG. 1) acquires the CPU frequency, the MCS Index, and the target group (UL) for the PHY timeslot from the MAC schedule analysis unit 115 (FIG. 1).

In step S42, the frequency control unit 114 determines the UL CPU frequency, in consideration of a safety factor for the lowest frequency. The safety factor may be fixedly determined by a maintenance person in advance. In addition, it may be dynamically changed according to the loading state, the radio wave state, and the like.

In step S43, the frequency control unit 114 acquires a UL CPU core from the control target table (FIG. 22).

In step S44, the frequency control unit 114 instructs the frequency control driver 141 (FIG. 1) to set the CPU frequency for the CPU core. The frequency control unit 114 may determine/control an uncore frequency after instructing the core frequency.

In step S45, the frequency control unit 114 records the UL MCS Index and CPU frequency in the CPU frequency setting history, and ends processing of the flow.

FIG. 36 shows a flowchart of controlling the CPU frequency in cases where UL/DL tasks are respectively loaded onto different CPU cores.

In step S51, the frequency control unit 114 (FIG. 1) acquires the CPU frequency, the MCS Index, and the target group (UL or DL) for the PHY timeslot from the MAC schedule analysis unit 115 (FIG. 1).

In step S52, the frequency control unit 114 determines whether the UL is included in the target group. If the UL is not included in the target group (S52: No), the processing proceeds to step S57.

If the UL is included in the target group (S52: Yes), the frequency control unit 114 in step S53 determines the UL CPU frequency in consideration of a safety factor for the lowest frequency. The safety factor may be fixedly determined by a maintenance person in advance. In addition, it may be dynamically changed according to the loading state, the radio wave state, and the like.

In step S54, the frequency control unit 114 acquires a UL CPU core from the control target table (FIG. 22).

In step S55, the frequency control unit 114 instructs the frequency control driver 141 (FIG. 1) to set the CPU frequency for the CPU core. The frequency control unit 114 may determine/control an uncore frequency after instructing the core frequency.

In step S56, the frequency control unit 114 records the UL MCS Index and CPU frequency in the CPU frequency setting history.

In step S57, the frequency control unit 114 determines whether the DL is included in the target group. If the DL is not included in the target group (S57: No), the processing of the flow ends.

If the DL is included in the target group (S57: Yes), the frequency control unit 114 in step S58 determines the DL CPU frequency, in consideration of a safety factor for the lowest frequency. The safety factor may be fixedly determined by a maintenance person in advance. In addition, it may be dynamically changed according to the loading state, the radio wave state, and the like.

In step S59, the frequency control unit 114 acquires a DL CPU core from the control target table (FIG. 21).

In step S60, the frequency control unit 114 instructs the frequency control driver 141 (FIG. 1) to set the CPU frequency for the CPU core. The frequency control unit 114 may determine/control an uncore frequency after instructing the core frequency.

In step S61, the frequency control unit 114 records the DL MCS Index and the DL CPU frequency in the CPU frequency setting history, and ends the processing of the flow.

### Second Embodiment

A second embodiment achieves power saving of an accelerator with controllable accelerator frequency and power-saving setting.

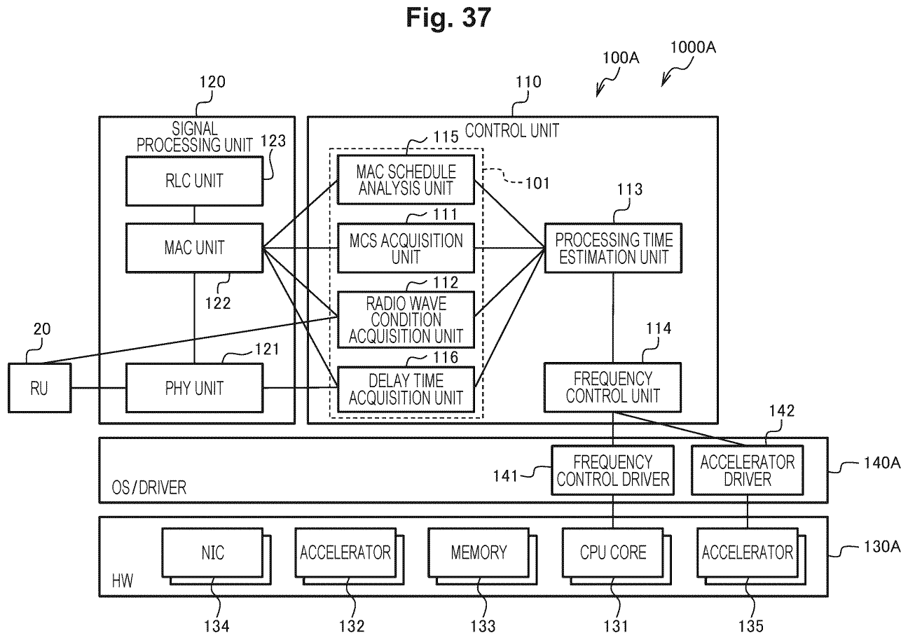

FIG. 37 shows a schematic configuration of a wireless access system according to a second embodiment of the present invention. The same components as those in FIG. 1 are denoted by the same reference signs as those used in FIG. 1, and duplicate descriptions thereof are skipped.

As illustrated in FIG. 37, a wireless access system 1000A includes an RU 20 and a communication control device 100A.

The communication control device 100A includes the control unit 110, the signal processing unit 120, hardware (HW) 130A, and an OS/driver 140A.

In the HW 130A, an accelerator 135 is added to the HW 130 in FIG. 1.

The accelerator 135 is an accelerator with a controllable accelerator frequency and power-saving setting.

In the OS/driver 140A, an accelerator driver 142 for controlling the accelerator 135 is added to the OS/driver 140 of FIG. 1.

The frequency control unit 114 of the control unit 110 controls the accelerator 135 according to the accelerator setting set by the frequency control unit 114 via the accelerator driver 142.

Similarly to the CPU frequency control described above, the frequency control unit 114 controls the accelerator 135 with controllable accelerator frequency and power-saving setting, based on estimation of the processing time for each accelerator frequency and setting (described below).

Here, the processing time estimation unit 113 determines accelerator setting, in consideration of a safety factor, when setting the accelerator.

Here, when the accelerator control has a larger power saving effect than the CPU frequency control, the frequency control unit 114 gives priority to the accelerator control. In the opposite case, priority is given to the CPU frequency control.

Examples of a method of controlling the accelerator 135 include the method described below.

The accelerator frequency is controlled.

Clock gating (to stop supply of clocking to the accelerator) is executed.

Power gating (to reduce voltage supplied to the accelerator) is executed.

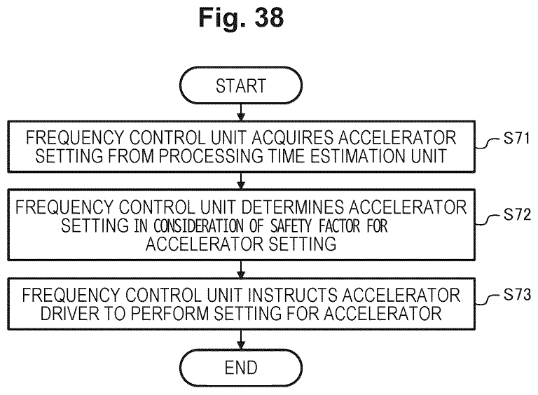

FIG. 38 shows a flowchart of controlling accelerator frequency by the frequency control unit 114.

In step S71, the frequency control unit 114 (FIG. 37) acquires an accelerator setting from the processing time estimation unit 113.

In step S72, the frequency control unit 114 determines accelerator setting, in consideration of a safety factor for the accelerator setting. The safety factor may be fixedly determined by a maintenance person in advance. In addition, it may be dynamically changed according to the loading state, the radio wave state, and the like.

In step S73, the frequency control unit 114 instructs the accelerator driver to perform setting for the accelerator, and ends processing of the flow.

### Third Embodiment

In a third embodiment, the uncore frequency of a CPU is controlled to achieve power saving of the CPU.

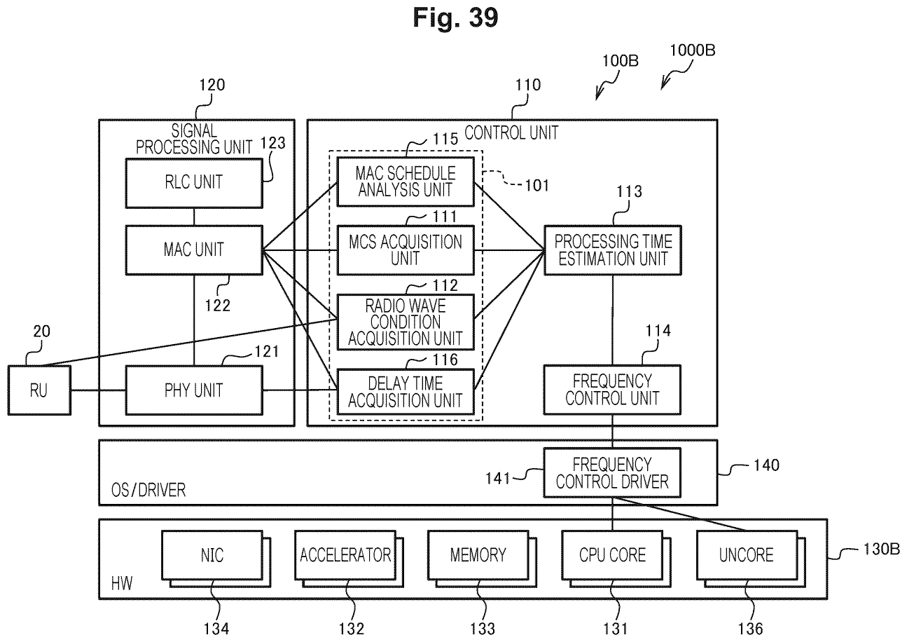

FIG. 39 shows a schematic configuration of a wireless access system according to the third embodiment of the present invention. The same components as those in FIG. 1 are denoted by the same reference signs as those used in FIG. 1, and duplicate descriptions thereof are skipped.

As illustrated in FIG. 39, a wireless access system 1000B includes the RU 20 and a communication control device 100B.

The communication control device 100B includes the control unit 110, the signal processing unit 120, hardware (HW) 130B, and the OS/driver 140.

In the HW 130B, an uncore 136 is added to the HW 130 in FIG. 1 (described below).

The frequency control unit 114 of the control unit 110 controls the uncore 136 via the frequency control driver 141 of the OS/driver 140.

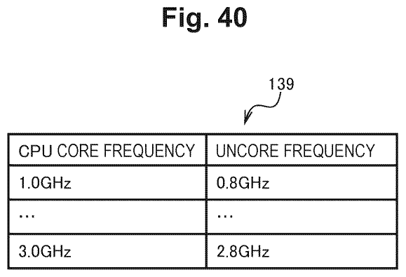

FIG. 40 illustrates an uncore setting table 139 read by the frequency control unit 114. The uncore setting table 139 (uncore setting storage unit) is stored in a memory (illustration omitted) of the control unit 110.

As illustrated in FIG. 40, the uncore setting table 139 stores setting information for changing the uncore frequency in addition to the CPU core frequency.

The frequency control unit 114 acquires an uncore frequency corresponding to the CPU core frequency in advance from the uncore setting table 139.

The frequency control unit 114 controls the uncore with an uncore frequency at which the uncore 136 does not become a bottleneck, on the basis of the setting information in the uncore setting table 139.

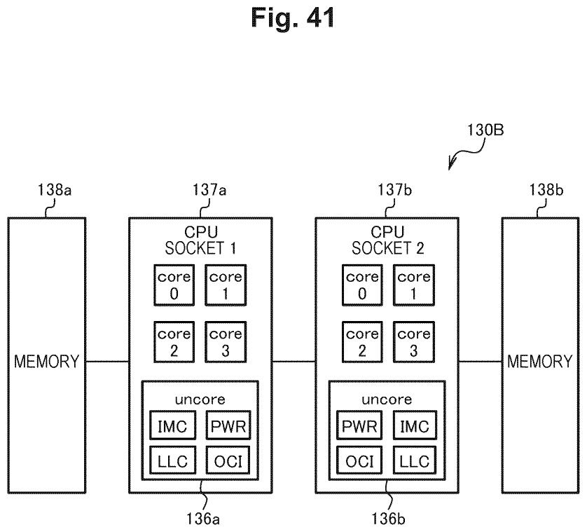

FIG. 41 illustrates a configuration of a CPU socket including a CPU core and an uncore.

As illustrated in FIG. 41, the HW 130B includes a CPU socket 137a, a memory 138a connected to the CPU socket 137a, a CPU socket 137b connected to the CPU socket 137a, and a memory 138b connected to the CPU socket 137b.

The CPU cores can be accommodated in the CPU socket 137a and the CPU socket 137b. The CPU socket 137a and the CPU socket 137b respectively include uncores 136a and 136b that are peripheral devices other than the CPU cores. The uncores 136a and 136b are each, for example, last level cache (LLC), on-chip interconnect (OCI), integrated memory controller (IMC), and power control logic (PWR), and these are controlled with the uncore frequency.

The difference between the core frequency and the uncore frequency will be described.

The core frequency is used to access control L2 Cache and elements in a physical core unit, which are anterior in data processing to said cache. The uncore frequency is used to access the LLC and elements in a package (socket) unit, which are posterior in data processing to the LLC.

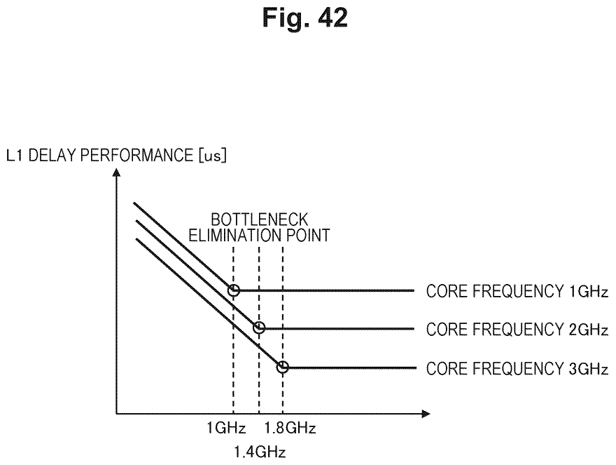

FIG. 42 shows a chart indicating delay performance (us) for the uncore frequency. The horizontal axis represents the uncore frequency (GHz), and the vertical axis represents the L1 delay performance (us). It can be seen that the higher the uncore frequency is, the lower the L1 delay performance (us) is.

In the present embodiment, the frequency at which the uncore becomes a bottleneck with respect to the core frequency is measured in advance and stored in the uncore setting table 139 in FIG. 40. The uncore frequencies read from the uncore setting table 139 in FIG. 40 are those marked with circles in FIG. 42 to eliminate bottlenecks.

Hereinafter, operation of the communication control device 100B configured as described above will be described.

In the present embodiment, not only the frequency control of the CPU core 131 but also the uncore frequency of the CPU is controlled on the premise that the timeslot processing is not affected. Specifically, after frequencies of the CPU cores 131 are determined for UL/DL tasks, frequencies of the uncores are determined. In addition, an uncore frequency, with which access to the LLC does not become a bottleneck with respect to a certain frequency of the CPU core 131, is measured in advance so as to be used for determining the uncore frequency.

### [Flowchart of Controlling Uncore Frequency]

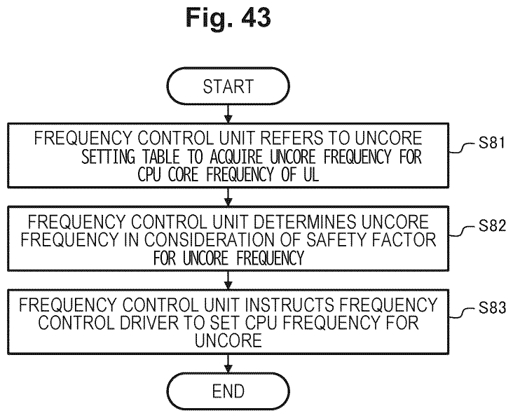

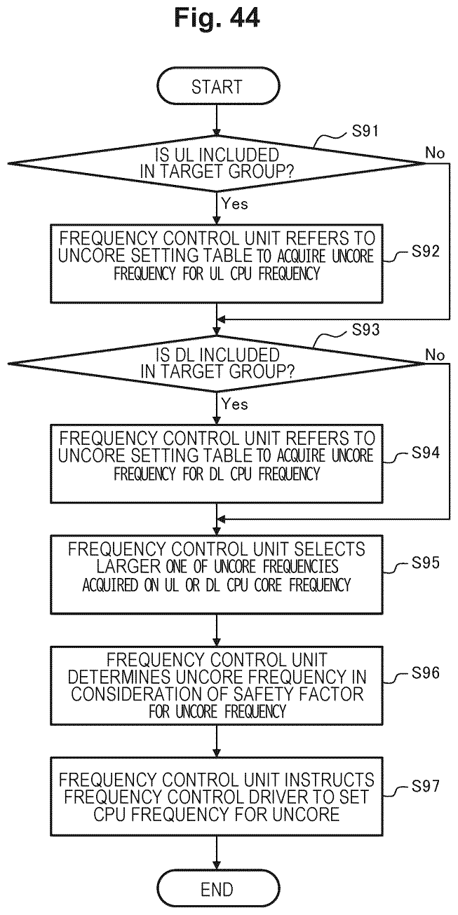

The uncore frequency control includes processing in a case where UL/DL tasks are loaded onto all over the controlled CPU cores (FIG. 43) and processing in a case where UL/DL tasks are respectively loaded onto different CPU cores (FIG. 44).

FIG. 43 is a flowchart of controlling uncore frequency in a case where UL/DL tasks are loaded onto all over the controlled CPU cores.

In step S81, the frequency control unit 114 refers to the uncore setting table to acquire the uncore frequency for the core frequency.

In step S82, the frequency control unit 114 determines the uncore frequency, in consideration of a safety factor for the uncore frequency. The safety factor may be fixedly determined by a maintenance person in advance. In addition, it may be dynamically changed according to the loading state, the radio wave state, and the like.

In step S83, the frequency control unit 114 instructs the frequency control driver 141 to set the CPU frequency for the uncore, and ends the processing of this flow.

FIG. 44 is a flowchart of controlling uncore frequency in a case where UL/DL tasks are respectively loaded onto different CPU cores.

In step S91, the frequency control unit 114 determines whether the UL is included in the target group. If the UL is not included in the target group (S91: No), the processing proceeds to step S93.

If the UL is included in the target group (S91: Yes), the frequency control unit 114 in step S92 refers to the uncore setting table to acquire the uncore frequency for the UL CPU core frequency.

In step S93, the frequency control unit 114 determines whether the DL is included in the target group. If the DL is not included in the target group (S93: No), the processing proceeds to step S95.

If the DL is included in the target group (S93: Yes), the frequency control unit 114 in step S94 refers to the uncore setting table to acquire the uncore frequency for the DL CPU core frequency.

In step S95, the frequency control unit 114 selects larger one of the uncore frequencies acquired based on the UL or DL CPU core frequency.

In step S96, the frequency control unit 114 determines the uncore frequency, in consideration of a safety factor for the uncore frequency. The safety factor may be fixedly determined by a maintenance person in advance. In addition, it may be dynamically changed according to the loading state, the radio wave state, and the like.

In step S97, the frequency control unit 114 instructs the frequency control driver 141 to set the CPU frequency for the uncore, and ends the processing of this flow.

### Hardware Configuration

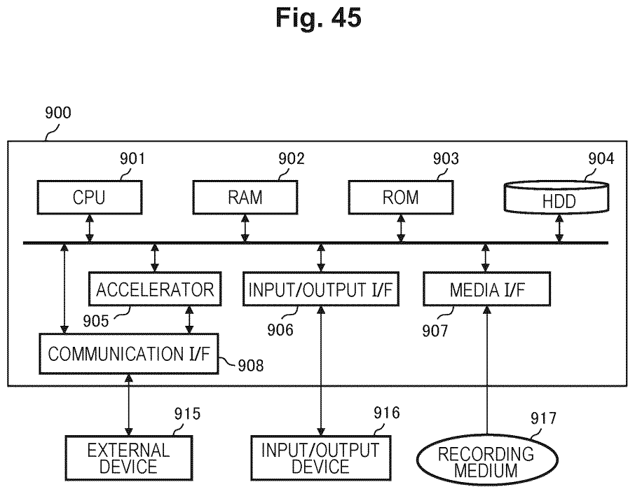

The communication control devices 100, 100A, and 100B (FIGS. 1, 37, and 39) of the wireless access systems 1000, 1000A, and 1000B (FIGS. 1, 37, and 39) according to the above-described embodiments are implemented by a computer 900 having a configuration as illustrated in FIG. 45, for example.

FIG. 45 shows an example hardware configuration of the computer 900 that implements the functions of the communication control devices 100, 100A, and 100B.

The communication control devices 100, 100A, and 100B include a CPU 901, a RAM 902, a ROM 903, an HDD 904, an accelerator 905, an input/output interface (I/F) 906, a media interface (I/F) 907, and a communication interface (I/F) 908. The accelerator 905 corresponds to the accelerator 132 in FIGS. 1, 37, and 39 and the accelerator 135 in FIG. 37.

The accelerator 905 is an accelerator (device) 132 (FIGS. 1, 37, and 39) that processes at least one of data from the communication I/F 908 and data from the RAM 902 at high speed. Note that the accelerator 905 may be of a type (Look-Aside type) that processes data from the CPU 901 or the RAM 902 and then returns the execution result to the CPU 901 or the RAM 902. On the other hand, the accelerator 905 may be of a type (In-line type) that is interposed between the communication I/F 908 and the CPU 901 or the RAM 902 and performs processing.

The accelerator 905 is connected to an external device 915 via the communication I/F 908. The input/output I/F 906 is connected to an input/output device 916. The media I/F 907 reads and writes data from and to a recording medium 917.

The CPU 901 operates on the basis of a program stored in the ROM 903 or the HDD 904 and controls units of the communication control devices 100, 100A, and 100B illustrated in FIGS. 1, 37, and 39 by executing the program (also referred to as an application or app as an abbreviation thereof) read in the RAM 902. The program may be distributed via a communication line, or recorded and distributed in the recording medium 917 such as a CD-ROM.

The ROM 903 stores a boot program to be executed by the CPU 901 when the computer 900 is activated, a program depending on hardware of the computer 900, and the like.

The CPU 901 controls the input/output device 916 including an input unit such as a mouse or a keyboard and an output unit such as a display or a printer, via the input/output I/F 906. The CPU 901 acquires data from the input/output device 916 and outputs generated data to the input/output device 916, via the input/output I/F 906. Note that a graphics processing unit (GPU) or the like may be used as a processor in conjunction with the CPU 901.

The HDD 904 stores a program to be executed by the CPU 901, data to be used by the program, and the like. The communication I/F 908 receives data from another device via a communication network (for example, network (NW)) and outputs the data to the CPU 901, and also transmits data generated by the CPU 901 to another device via the communication network.

The media I/F 907 reads a program or data stored in the recording medium 917 and outputs the program or data to the CPU 901 via the RAM 902. The CPU 901 loads a program for an intended process from the recording medium 917 onto the RAM 902 via the media I/F 907 and executes the loaded program. The recording medium 917 is an optical recording medium such as a digital versatile disc (DVD) or a phase change rewritable disk (PD), a magneto-optical recording medium such as a magneto optical disk (MO), a magnetic recording medium, a conductor memory tape medium, a semiconductor memory, or the like.

For example, in a case where the computer 900 functions as the communication control device 100, 100A, or 100B (FIGS. 1, 37, and 39) configured as one device according to the present embodiment, the CPU 901 of the computer 900 implements the functions of the communication control device 100, 100A, or 100B by executing a program loaded on the RAM 902. In addition, the HDD 904 stores data in the RAM 902. The CPU 901 reads the program for an intended process from the recording medium 917 and executes the program. Additionally, the CPU 901 may read the program for an intended process from another device via the communication network.

### Advantageous Effects

As described above, the communication control device 100 (FIG. 1) that processes a radio access signal includes the communication quality information acquisition unit 101 that acquires communication quality information, the processing time estimation unit 113 that calculates an estimated processing time for each CPU frequency from the acquired communication quality information, and the frequency control unit 114 that lowers the CPU frequency than a currently set CPU frequency, within a range where the estimated processing time is equal to or less than a processing time of a timeslot.

As described above, the communication control device 100 can achieve power saving by lowering the CPU frequency so that the processing completes just barely within the timeslot. That is, the device can reduce the power consumption of the server, while keeping the processing time limit, by constantly changing the CPU frequency to the optimum one by timeslot, instead of continuously setting the highest performance of the CPU core in order to complete all the processing within the timeslot as in the conventional cases. As a result, the communication control device 100 can reduce power consumption of the CPU, while meeting the high-speed processing demand, in the case of configuring a vRAN system or the like.

In addition, since the processing time estimation unit 113 calculates the estimated processing time for each CPU frequency from the acquired communication quality information, the device can achieve setting of the CPU frequency in a fine time scale of several hundred us without touching the PHY or the MAC app (without making modifications).

In the communication control device 100, the communication quality information acquisition unit 101 works as the modulation and coding scheme (MCS) acquisition unit 111 that acquires an UP Link (UL) or Down Link (DL) MCS Index for the MAC timeslot, as the communication quality information.

In this way, the communication control device 100 (processing time estimation unit 113) can estimate the processing time in a PHY-high layer using the MCS Index as the communication quality information (radio quality information) and determine the setting of the lower (lowest depending on the situation) CPU frequency or the like from the estimated processing time.

In the communication control device 100, the communication quality information acquisition unit 101 works as the radio wave condition acquisition unit 112 that acquires the UP Link (UL) or Down Link (DL) radio wave quality information as the communication quality information.

In this way, the communication control device 100 (processing time estimation unit 113) can estimate the processing time in a PHY-high layer using the radio wave quality information, such as an SINR, as the communication quality information (radio quality information) and determine the setting of the lower (lowest depending on the situation) CPU frequency or the like from the estimated processing time. This allows for the setting, even when the MCS Index is not acquired/cannot be acquired. In addition, the control accuracy can be further enhanced in combination with the MCS Index.

In the communication control device 100, the communication quality information acquisition unit 101 works as the MAC schedule analysis unit 115 that acquires the radio resource arrangement information including the MAC schedule information, as the communication quality information.

In this way, the communication control device 100 (processing time estimation unit 113) can achieve accuracy improvement in both directions, in consideration of the DL processing, and further power saving in the PHY timeslot which does not need to be handled, by using the MAC schedule information as the communication quality information (radio quality information).

In the communication control device 100, the communication quality information acquisition unit 101 works as the delay time acquisition unit 116 that calculates a delay time from an actual measurement value of the PHY-high processing time and acquires the delay time as the communication quality information.

In this way, the communication control device 100 (processing time estimation unit 113) can estimate the processing time in a PHY-high layer using the delay time based on the actual measurement value of the PHY-high processing time, as the communication quality information (radio quality information), and determine the setting of the lower (lowest depending on the situation) CPU frequency or the like from the estimated processing time.

In the communication control device 100, the frequency control unit 114 determines the CPU frequency, in consideration of a safety factor for the CPU frequency set by the processing time estimation unit.

In this way, the communication control device 100 (frequency control unit 114) determines the CPU frequency, in consideration of the safety factor, to allow for lowering the CPU frequency to reliably complete the processing within the timeslot. In addition, the method of considering the safety factor can be achieved without rewriting the study results table that associates the PHY-high processing time for each MCS Index or radio wave quality information with the CPU frequency.

In the communication control device 100, the processing time estimation unit 113 includes a study results table that associates the PHY-high processing time for each MCS Index or radio wave quality information with the CPU frequency, and the processing time estimation unit 113 refers to the study results table to determine the lowest frequency among the CPU frequencies in the study results table, within a range where the estimated processing time is equal to or less than the processing time of the timeslot.

In this way, the communication control device 100 (frequency control unit 114) can set the CPU frequency, with which the processing completes just barely within the timeslot, with reference to the learning table.

In the communication control device 100, the processing time estimation unit 113 includes a study results table that associates the PHY-high processing time for each MCS Index or radio wave quality information with the CPU frequency, and the processing time estimation unit 113 refers to the study results table to execute feedback of rewriting the table value in the study results table, based on the actual measurement value of the PHY-high processing time.

In this way, the communication control device 100 (processing time estimation unit 113) can rewrite the table value in the study results table with the latest communication state or the like, by way of the feedback. In addition, feedback is applied in estimating processing time of the PHY-high, on the basis of time stamp information acquired by the PHY and the presence or absence of a retransmission request. As a result, the processing time estimation unit 113 can set the CPU frequency more accurately, with which the processing completes just barely within the timeslot.

The communication control device 100A (FIG. 37) includes the accelerator 135 (FIG. 37) that performs computing of specific processing of an application offloaded thereto, and the accelerator driver 142 that controls the accelerator 135 (FIG. 37) according to accelerator setting set by the frequency control unit 114, and the processing time estimation unit 113 determines the accelerator setting, in consideration of a safety factor for the accelerator setting.

As described above, the communication control device 100A can reduce the power consumption of the server by constantly changing the accelerator setting to the optimum one by timeslot.

The communication control device 100B (FIG. 39) includes the CPU core 131 (FIG. 39), the uncore 136 (FIG. 39) that is a peripheral device other than the CPU core, and the uncore setting storage unit (uncore setting table 139) (FIG. 39) that stores an uncore frequency for the CPU core frequency, and the frequency control unit 114 (FIG. 39) controls the uncore with the uncore frequency to prevent the uncore from becoming a bottleneck, based on setting information in the uncore setting storage unit.

As described above, the communication control device 100B can reduce the power consumption of the hardware including the uncore 136, by constantly changing the uncore frequency to the optimum one by timeslot. The wireless access system (FIG. 46: VRAN system 1) includes: a base station that processes a radio access signal; and the communication control device 100 (FIG. 1) that controls a CPU frequency of a CPU core arranged in hardware at the base station, wherein the communication control device 100 includes: the processing time estimation unit 113 that calculates an estimated processing time for each CPU frequency from communication quality information; and the frequency control unit 114 that lowers the CPU frequency within a range where the estimated processing time is equal to or less than the processing time of a timeslot.

In this way, the wireless access system can reduce power consumption of a CPU and an accelerator, while meeting the demand of high-speed processing in a case of configuring a vRAN system or the like. That is, the wireless access system can reduce the power consumption of the server by constantly changing the CPU frequency and accelerator setting to the optimum ones by timeslot.

Note that, in each of the above embodiments, in the case of frequency division duplex (FDD) instead of time division duplex (TDD), the timing of simultaneous processing for both UL/DL directions increases in a PHY layer, but the logic of estimating processing time and the frequency control method can be applied as with TDD.

In addition, among the processes described in each of the above embodiment, all or some of the pieces of processing described as being automatically performed can be manually performed, or all or some of the processes described as being manually performed can be automatically performed by a known method. Additionally, processing procedures, control procedures, specific names, and information including various types of data and parameters illustrated in the specification and the drawings can be arbitrarily changed unless otherwise specified.

In addition, each component of each device that has been illustrated is functionally conceptual, and is not necessarily physically configured as illustrated. That is, a specific form of distribution and integration of individual devices is not limited to the illustrated form, and all or a part of the configuration can be functionally or physically distributed and integrated in any unit according to various loading and usage conditions, and the like.

In addition, some or all of the components, functions, processing units, processing means, and the like described above may be implemented by hardware, for example, by designing them as integrated circuits. In addition, the components, functions, and the like may be implemented by software for causing a processor to interpret and execute a program to implement the respective functions. Information such as programs, tables, and files for implementing the respective functions can be held in a recording device such as a memory, a hard disk, or a solid state drive (SSD), or in a recording medium such as an integrated circuit (IC) card, a secure digital (SD) card, or an optical disc.

### REFERENCE SIGNS LIST

10 UE (terminal)
20 RU
30 DU server (base station)
33 vDU
100, 100A, 100B Communication control device
101 Communication quality information acquisition unit
110 Control unit
111 MCS acquisition unit (communication quality information acquisition unit)
112 Radio wave condition acquisition unit (communication quality information acquisition unit)
113 Processing time estimation unit
114 Frequency control unit
115 MAC schedule analysis unit (communication quality information acquisition unit)
116 Delay time acquisition unit (communication quality information acquisition unit)
120 Signal processing unit
121 PHY unit
122 MAC unit
123 RLC unit
130, 130A, 130B Hardware (HW)
131 CPU core
132, 135 Accelerator
133 Memory
134 NIC
136 Uncore
139 Uncore setting table (uncore setting storage unit)
140, 140A OS/driver
141 Frequency control driver
142 Accelerator driver
1000, 1000A, 1000B Wireless access system

1. A communication control device that processes a radio access signal, the communication control device comprising at least one processor and a memory configured to execute functions of:
a communication quality information acquisition unit that acquires communication quality information;
a processing time estimation unit that calculates an estimated processing time for each CPU frequency from the acquired communication quality information; and
a frequency control unit that lowers the CPU frequency than a currently set CPU frequency, within a range where the estimated processing time is equal to or less than a processing time of a timeslot.

2. The communication control device according to claim 1, wherein the communication quality information acquisition unit works as a modulation and coding scheme (MCS) acquisition unit that acquires an UP Link (UL) or Down Link (DL) MCS Index for a MAC timeslot, as the communication quality information.

3. The communication control device according to claim 1, wherein the communication quality information acquisition unit works as a radio wave condition acquisition unit that acquires UP Link (UL) or Down Link (DL) radio wave quality information, as the communication quality information.

4. The communication control device according to claim 1, wherein the communication quality information acquisition unit works as a MAC schedule analysis unit that acquires radio resource arrangement information including MAC schedule information, as the communication quality information.

5. The communication control device according to claim 1, wherein the communication quality information acquisition unit works as a delay time acquisition unit that calculates a delay time from an actual measurement value of a PHY-high processing time and acquires the delay time as the communication quality information.

6. The communication control device according to claim 1, wherein the frequency control unit determines a CPU frequency, in consideration of a safety factor for the CPU frequency set by the processing time estimation unit.

7. The communication control device according to claim 1, wherein
the processing time estimation unit includes a study results table that associates a PHY-high processing time for each MCS Index or radio wave quality information with the CPU frequency, and
the processing time estimation unit refers to the study results table to determine a lowest frequency among CPU frequencies in the study results table, within a range where the estimated processing time is equal to or less than the processing time of the timeslot.

8. The communication control device according to claim 1, wherein
the processing time estimation unit includes a study results table that associates a PHY-high processing time for each MCS Index or radio wave quality information with the CPU frequency, and
the processing time estimation unit refers to the study results table to execute feedback of rewriting a table value in the study results table, based on an actual measurement value of the PHY-high processing time.

9. The communication control device according to claim 1, comprising:
an accelerator that performs computing of specific processing of an application offloaded thereto; and
an accelerator driver that controls the accelerator according to accelerator setting set by the frequency control unit,
wherein
the frequency control unit determines the accelerator setting, in consideration of a safety factor for the accelerator setting.

10. The communication control device according to claim 1, comprising:
a CPU core;
an uncore that is a peripheral device other than the CPU core; and
an uncore setting storage unit that stores an uncore frequency for an CPU core frequency,
wherein
the frequency control unit controls the uncore with an uncore frequency to prevent the uncore from becoming a bottleneck, based on setting information in the uncore setting storage unit.

11. A wireless access system comprising:
a base station that processes a radio access signal; and
a communication control device that controls a CPU frequency of a CPU core arranged in hardware at the base station,
wherein the communication control device includes:
a communication quality information acquisition unit that acquires communication quality information;
a processing time estimation unit that calculates an estimated processing time for each CPU frequency from the communication quality information; and
a frequency control unit that lowers the CPU frequency than a currently set CPU frequency within a range where the estimated processing time is equal to or less than a processing time of a timeslot.

12. A communication control method of a communication control device that processes a radio access signal, the method comprising:
acquiring communication quality information;
calculating an estimated processing time for each CPU frequency from the acquired communication quality information; and
lowering the CPU frequency than a currently set CPU frequency, within a rage where the estimated processing time is equal to or less than a processing time of a timeslot.

13. A non-transitory computer-readable medium storing a program for causing a computer to function as the communication control device according to claim 1.
